(19) United States
(12) Patent Application Publication
(10) Pub. No.: US 2026/0083105 A1
(43) Pub. Date: Mar. 26, 2026

(54) OXYGENATION ASSEMBLY FOR AQUACULTURE, AND DIFFUSER THEREOF

(71) Applicant: Poseidon Ocean Systems Ltd., Campbell River (CA)

(72) Inventors: Evan LOGUE, Campbell River (CA); Mathew Stephen CLARKE, Campbell River (CA)

(73) Assignee: Poseidon Ocean Systems Ltd., Campbell River (CA)

(21) Appl. No.: 19/410,051

(22) Filed: Dec. 5, 2025

Related U.S. Application Data
(63) Continuation of application No. PCT/CA2024/051061, filed on Aug. 14, 2024.
(60) Provisional application No. 63/519,976, filed on Aug. 16, 2023.

(51) Int. Cl. A01K 63/04; B01F 23/231; B01F 23/237; B01F 25/00; B01F 25/20; B01F 25/21; B01F 25/312; B01F 35/71; B01F 101/00

(52) U.S. Cl. CPC A01K 63/042; B01F 23/23121; B01F 23/237611; B01F 25/21; B01F 25/28; B01F 25/31252; B01F 35/712; B01F 35/7176; B01F 2025/911; B01F 2025/912; B01F 2025/916; B01F 2101/305

(57) ABSTRACT

There is provided an oxygenation assembly and an aquaculture diffuser thereof. The diffuser includes a plurality of circumferentially spaced-apart gas injection ports. The diffuser includes a plurality of circumferentially spaced-apart and axially-extending passageways. Each axially-extending passageway aligns with a respective one of the gas injection ports. Each axially-extending passageway is shaped to receive a mixture of water and oxygen-containing gas therethrough. The diffuser includes a plurality of circumferentially spaced-apart and radially outwardly-extending passageways. Each radially-extending passageway is in fluid communication with a respective one of the axially-extending passageways. Each said passageway may include an intensifier or constriction between proximal and distal end portions thereof. The diffuser may include a plurality of circumferentially spaced-apart expansion chambers each positioned between and in fluid communication with a respective said axially-extending passageway and a corresponding respective said radially-extending passageway. The diffuser is shaped to induce a homogeneous ramping turbulent kinetic energy (TKE) dissipation field.

### BACKGROUND OF THE INVENTION

### Field of the Invention

There is provided an oxygenation assembly. In particular, there is provided an oxygenation assembly for aquaculture and a diffuser thereof.

### Description of the Related Art

Japanese Patent No. 4893365 B2 to Yasuhiro et al. discloses an apparatus for generating micro bubbles with a circulation channel from which the gas-liquid mixed phase flow is supplied. A pressure receiving part receives the gas-liquid mixed phase flow at one end side of the circulation channel. A discharge channel generates micro bubbles by introducing the gas-liquid mixed phase flow from the side face of the circulation channel at the proximity of the pressure receiving part. The discharge channels are plurally connected with the side face of the circulation channel. The inner surface of the discharge channel is formed to a taper shape so that the exit diameter of the discharge channel becomes a large diameter. The individual discharge channel is radially connected around the axis of the circulation channel as a center. The individual discharge channel is arranged so that micro bubbles are discharged to the axis direction of the circulation channel. The surface of the pressure receiving part to receive the gas-liquid mixed phase flow is subjected to bending processing. The aperture angle of the discharge channel may be set so that the differential pressure of the entrance and exit of the discharge channel become maximum.

Korean Patent Reference No. KR101863769B1 to Sanghwa discloses a micro-bubble generator in which the size of a bubble can be adjusted to a micrometer or a nanometer level and the generated bubble stably exists in a liquid phase for a long time. The micro bubble generator of includes a center portion in which an inflow path into which the gas is introduced and a side surface is formed with a discharge port connected to the inflow path. A collision cover is positioned between the impact surface and the center portion. A swirling space portion is provided so that the liquid colliding with the impact surface can swing around the center portion. A housing is coupled to the impact cover at the outside of the impact cover and inserted into a discharge path formed at the other side of the center portion.

U.S. Pat. No. 4,556,523 to Lecoffre discloses a microbubble injector usable to separate materials of different density by flotation. A deflector wall deflects radially a flow of water exiting under pressure from an injector hole and containing dissolved air at the saturation concentration. This procures cavitation which is localized at the edges of the hole and which generates the required microbubbles of air downflow thereof.

U.S. Pat. No. 5,054,423 to Escobal discloses an air delivery system. The air delivery system introduces a selected amount of aspirated air into a stream of water conducted within a tube. The aspirated air being conducted in an air conducting tube has one end open to the atmosphere. The delivery system includes a flow system in the water tube which has a variable diameter throat and an axis. The delivery system includes an outlet system for discharging air into the water stream in a variable spaced relation to the throat. The delivery system includes a telescoping system for adjusting the spaced relation of telescopically related water conducting members. The delivery system includes a connector between one end of the telescopically related members and the water tube. Movement of the telescopically related water conducting members relative to the throat varies the space between the throat and the air outlet system and accordingly varies the water flow area and the amount of aspirated air.

The above-described prior art may suffer a number of disadvantages.

### BRIEF SUMMARY OF INVENTION

There is provided, and it is an object to provide, an improved oxygenation system and diffuser thereof, disclosed herein.

There is accordingly provided an aquaculture diffuser according to one aspect. The diffuser includes a first plurality of circumferentially spaced-apart passageways configured to direct oxygen-injected water axially upwards. The diffuser includes a second plurality of circumferentially spaced-apart passageways in fluid communication with respective ones of the first plurality of circumferentially spaced-apart passageways and configured to re-direct the oxygen-injected said water radially outwards.

There is also provided an aquaculture diffuser according to another aspect. The diffuser includes a plurality of circumferentially spaced-apart gas injection ports. The diffuser includes a plurality of circumferentially spaced-apart and axially-extending passageways. Each axially-extending passageway aligns with a respective one of the gas injection ports. Each axially-extending passageway is shaped to receive a mixture of water and oxygen-containing gas therethrough. The diffuser includes a plurality of circumferentially spaced-apart and radially outwardly-extending passageways. Each radially-extending passageway is in fluid communication with a respective one of the axially-extending passageways.

There is further provided an aquaculture diffuser according to an additional aspect. The diffuser includes a plurality of axially-extending channels. Each channel is an annular sector in cross-section and is configured to receive water and gas therethrough. The diffuser includes a plurality of radially-extending channels above. The radially-extending channels operatively connect to respective said axially-extending channels.

There is yet also provided an aquaculture diffuser according to a further aspect. The diffuser includes a plurality of circumferentially spaced-apart gas injection ports. The diffuser includes a plurality of circumferentially spaced and radially-extending dividing members positioned between respective said oxygen injection ports. The dividing members are configured to divide incoming axial water flow and bubbles into multiple mixing channels.

There is yet additionally provided an aquaculture diffuser according to yet another aspect. The diffuser includes a plurality of circumferentially spaced-apart gas injection ports. The diffuser includes a plurality of circumferentially spaced and axially-extending passageways aligning with and in fluid communication with respective ones of said ports. The diffuser includes a plurality of circumferentially spaced and radially outwardly-extending expansion chambers aligning with and in fluid communication with respective ones of said axially-extending passageways.

There is yet further provided an aquaculture diffuser according to yet an additional aspect. The diffuser includes a plurality of circumferentially spaced-apart gas injection ports. The diffuser includes a plurality of circumferentially spaced and axially-extending intensifiers or axial intensifiers or constrictions aligning with and in fluid communication with respective ones of said ports and shaped to promote acceleration of mixtures of water and gas axially upwards. The diffuser includes a plurality of circumferentially spaced and radially outwardly-extending expansion chambers aligning with and in fluid communication with respective ones of said intensifiers.

There is also provided an aquaculture diffuser according to another aspect. The diffuser includes at least one gas injection port. The diffuser includes a first elongate passageway in fluid communication with the gas injection port and extending along a first axis. The diffuser includes a second elongate passageway aligning with and in fluid communication with the first elongate passageway. The second elongate passageway extends along a second axis perpendicular to the first axis. The first elongate passageway has in lateral section a height to width ratio that is greater than that of the second elongate passageway.

There is additionally provided an aquaculture diffuser according to a further aspect. The diffuser includes at least one gas injection port. The diffuser includes a first elongate passageway in fluid communication with the gas injection port and extending along a first axis. The diffuser includes a second elongate passageway aligning with and in fluid communication with the first elongate passageway. The second elongate passageway extends along a second axis perpendicular to the first axis. The second elongate passageway is wider in lateral cross-section than that of the first elongate passageway and/or the second elongate passageway is rectangular in lateral cross-section.

There is yet also provided an aquaculture diffuser according to yet another aspect. The diffuser includes at least one gas injection port. The diffuser includes at least one axially-extending passageway in fluid communication with the gas injection port. The diffuser includes at least one radially outwardly-extending passageway aligning with and in fluid communication with the at least one axially-extending passageway.

There is further provided an aquaculture diffuser according to yet an additional aspect. The diffuser includes a hub having a plurality of circumferentially spaced-apart gas injection ports. The diffuser includes an annular member extending about the hub at least in part. The annular member has a plurality of circumferentially spaced and axially-extending openings extending therethrough. The openings aligns with respective ones of the ports. The diffuser includes an axially-constricting member having a plurality of circumferentially spaced and axially-extending passageways extending therethrough. The axially-extending passageways align with and are smaller in extent than the openings of the annular member. The diffuser includes a radially-extending member having a plurality of circumferentially spaced and radially outwardly-extending passageways. The radially outwardly-extending passageways align with and are in fluid communication with respective ones of the axially-extending passageways.

There is additionally provided an aquaculture diffuser according to another aspect. The diffuser is configured to direct bubble-containing water radially and circumferentially outwards therefrom so as to form a first bubble plume portion that tapers in an upward direction. The diffuser is configured to form a plurality of circumferentially spaced-apart recirculation zones comprising outwardly positioned water flowing both upwards radially inwards and then axially downwards towards the diffuser once more, and so as to form a second bubble plume portion above the first bubble plume portion. The second bubble plume portion flares outwards in the upward direction.

There is further provided an aquaculture diffuser according to an additional aspect. The diffuser includes a plurality of pathways via which gas is dispersed within a flow of water and directed axially upwards and then radially outwards. Each pathway is shaped to undergo in lateral section a height to width ratio change in the transition between axial and radial said flow.

There is also provided an aquaculture diffuser according to yet an additional aspect. The diffuser includes at least one axially-extending passageway shaped to receive a mixture of water and bubbles therethrough. The diffuser includes an axial intensifier or constriction within the at least one axially-extending passageway. The diffuser includes a width-expanding, radially-extending expansion chamber downstream of the axial intensifier.

There is yet also provided an aquaculture diffuser according to another aspect. The diffuser includes at least one axially-extending passageway shaped to receive a mixture of water and bubbles therethrough. The diffuser includes at least one radially-extending passageway and/or expansion chamber downstream of the at least one axially-extending passageway. Each said passageway has a constriction between proximal and distal end portions thereof.

There is additional provided an aquaculture diffuser according to a further aspect. The diffuser includes an axially-extending passageway shaped to increase the velocity and turbulent kinetic energy (TKE) of a mixture of water and gas bubbles passing therethrough. The diffuser includes a radially-extending passageway downstream of the axially-extending passageway. The radially-extending passageway is configured to re-direct flow of the mixture from an axial to a radial direction. The diffuser is shaped to induce a homogeneous ramping turbulent kinetic energy (TKE) dissipation field.

There is further provided an aquaculture diffuser according to another aspect. The diffuser includes an axially-extending passageway shaped to receive a mixture of water and gas bubbles. The diffuser includes an axial intensifier element positioned within the axially-extending passageway. The axial intensifier element is shaped to increase the velocity and turbulent kinetic energy (TKE) of the mixture. The diffuser includes a radially-extending passageway downstream of the axial intensifier element which causes the mixture to change from an axial to a radial direction. The diffuser so shaped induces a homogeneous ramping turbulent kinetic energy (TKE) dissipation field.

There is also provided an aquaculture diffuser according to a further aspect. The diffuser includes a plurality of circumferentially spaced-apart gas injection ports. The diffuser includes a plurality of circumferentially spaced-apart and radially outwardly-extending passageways each in fluid communication with a respective one of the ports. The diffuser includes a plurality of outlet jets operatively connecting to respective ones of said passageways. Each outlet jet has an inner circumference to cross-sectional area ratio that is greater than that of a circle and/or square.

There is additionally provided an aquaculture diffuser according to yet another aspect. The diffuser includes a plurality of circumferentially spaced-apart gas injection ports. The diffuser includes a plurality of circumferentially spaced-apart and radially outwardly-extending passageways each in fluid communication with a respective one of the ports. The diffuser includes a plurality of outlet jets operatively connecting to respective ones of the passageways. Each outlet jet is rectangular in cross-section and/or has cross-sectional width that is greater than that of a cross-sectional height thereof.

There is also provided an aquaculture diffuser thereof according to a further aspect. The diffuser includes a plurality of circumferentially spaced-apart gas injection ports. The diffuser includes a plurality of circumferentially spaced-apart and axially-extending passageways. Each axially-extending passageway aligns with a respective one of the gas injection ports. Each axially-extending passageway is shaped to receive a mixture of water and oxygen-containing gas therethrough. The diffuser includes a plurality of circumferentially spaced-apart and radially outwardly-extending passageways. Each radially-extending passageway is in fluid communication with a respective one of the axially-extending passageways. Each said passageway may include an intensifier or constriction between proximal and distal end portions thereof. The diffuser may include a plurality of circumferentially spaced-apart expansion chambers each positioned between and in fluid communication with a respective said axially-extending passageway and a corresponding respective said radially-extending passageway. The diffuser is shaped for each said expansion chamber to induce a homogeneous ramping turbulent kinetic energy (TKE) dissipation field therein. The diffuser is shaped for each said radial intensifier to promote a peak said turbulent kinetic energy (TKE) dissipation adjacent thereto.

There is further provided an aquaculture diffuser according to yet another aspect. The diffuser includes at least one axially-extending passageway shaped to receive a mixture of gas bubbles and water therethrough. The axially-extending passageway is configured to produce a first venturi effect thereon. The diffuser includes at least one radially-extending passageway downstream of the at least one axially-extending passageway. The radially-extending passageway is configured to produce a second venturi effect on said mixture.

There is additionally provided an aquaculture diffuser according to yet a further aspect. The diffuser includes a plurality of circumferentially spaced-apart and axially-extending passageways shaped to increase the velocity of a mixture of gas bubbles and water extending therethrough. The diffuser includes a plurality of expansion chambers downstream of respective ones of said axially-extending passageways. The diffuser includes a plurality of circumferentially spaced-apart and radially-extending passageways downstream of respective ones of said expansion chambers. The radially-extending passageways are shaped to receive and increase the velocity of the mixture once more so as to jet and/or eject said mixture about and radially-outwards from the diffuser.

There is also provided an oxygenation assembly according to one aspect. The oxygenation assembly includes any one of the above-described diffusers. The oxygenation assembly includes i) a pump via which water is directed to the diffuser; and/or ii) includes or is connectable to a pressurized oxygen-enriched gas source via which oxygen-containing gas is directed to the diffuser.

There is further provided a method of diffusing and/or dissolving gas bubbles in water according to one aspect. The method includes jetting a diffuser bubble-containing water radially and circumferentially outwards so as to form a first bubble plume portion that tapers in an upward direction. The method includes entraining water adjacent thereto via said jetting so as to form a plurality of circumferentially spaced-apart recirculation zones comprising rising water flowing radially inwards and then axially downwards towards the diffuser once more, and so as to form a second bubble plume portion that flares outwards in the upward direction.

There is also provided a method of diffusing and/or dissolving gas bubbles in water according to another aspect. The method includes jetting radially outwards via a diffuser bubble-containing water radially so as to form a bubble plume. The method includes entraining water adjacent thereto via said jetting so as to form a plurality of circumferentially spaced-apart recirculation zones comprising rising water flowing radially inwards and then axially downwards towards the diffuser once more. The method includes causing the bubble plume to taper inwards via said recirculation zones.

There is additionally provided a method of forming a bubble plume with a prolonged contact time between gas bubbles and a body of water to which the bubbles are dispersed. The method includes jetting radially and circumferentially outwards via a diffuser a mixture of the gas bubbles and water at a velocity sufficient to i) inhibit initial entrainment of the mixture upwards, thereby promoting a prolonged contact time between the bubbles and the body of water; and ii) promote entrainment exterior to the diffuser, and thereby increasing water flow in the jetting, decreasing gas holdup within the diffuser, and inhibiting bubble coalescence.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention:

FIG. 1 is an partially schematic elevation view of an oxygenation assembly according to one aspect, the oxygenation assembly including a diffuser, a pump configured to direct pressurized water to the diffuser and an oxygen-enriched gas source via which oxygen-containing gas is directed to the diffuser;

FIG. 2 is an elevation view of the pump and diffuser thereof, together with a conduit shown coupling the pump and diffuser together according to one non-limiting embodiment;

FIG. 3A is a front elevation view of a manifold assembly via which the pump and diffuser of FIG. 2 connect;

FIG. 3B is a sectional elevation view taken along lines of 3B-3B of the manifold assembly, pump and diffuser of FIG. 3A, with the pump shown therewithin coupled to the diffuser;

FIG. 4 is a side, bottom perspective view of the diffuser of the oxygenation assembly of FIG. 1;

FIG. 5 is a bottom plan view thereof;

FIG. 6 is an enlarged bottom, side perspective of the diffuser thereof, with the diffuser including a gas injection hub having a plurality of circumferentially spaced-apart gas injection ports, together with a plurality of circumferentially spaced-apart and axially-extending passageways including axial intensifiers aligning with respective ones of said ports;

FIG. 7 is an enlarged bottom, side perspective of the diffuser thereof, with lower housing portions of the diffuser being removed to reveal a plurality of circumferentially spaced-apart and radially-extending passageways together with a plurality of circumferentially spaced-apart expansion chambers, each positioned between and in fluid communication with a respective said axial intensifier and a corresponding said radially-extending passageway;

FIG. 8 is a bottom, side perspective view of the diffuser thereof, with the lower housing portion and axially-extending passageways thereof being removed to fully reveal the expansion chambers and radially-extending passageways thereof, with each said radially-extending passageway including a radial intensifier;

FIG. 9 is a partially schematic, sectional elevation view taken along lines 9-9 of the diffuser of FIG. 5 to reveal one said axially-extending passageway including axial intensifier, together with one said radially-extending passageway including radial intensifier and a corresponding said expansion chamber extending therebetween;

FIG. 10A is a partially schematic, sectional elevation view of the diffuser similar to FIG. 9 with non-limiting and exemplary turbulent kinetic energy (TKE) dissipation fields shown thereon;

FIG. 10B is a partially schematic, bottom plan view of the diffuser thereof, showing expansion chambers together with corresponding radially-extending passageways including radial intensifiers, with non-limiting and exemplary turbulent kinetic energy (TKE) dissipation fields of FIG. 10A shown thereon;

FIG. 11 is a top plan and partially schematic view of a pattern of dispersal of the mixture of water and gas bubbles outputted from and jetting radially outwards and about the diffuser of FIG. 1;

FIG. 12A is a front elevation view of an oxygenation assembly and diffuser therefor according to another aspect, with the oxygenation assembly including a manifold assembly via which a pump and diffuser of the oxygenation assembly connect;

FIG. 12B is a side elevation view thereof;

FIG. 12C is a sectional elevation view taken along lines of 12C-12C of the manifold assembly, pump and diffuser of FIG. 12A, with the pump shown therewithin coupled to the diffuser;

FIG. 13 is a front elevation view of the pump and a conduit of FIG. 12C for coupling to the diffuser of FIG. 12C;

FIG. 14 is a bottom, side perspective view of the diffuser of FIG. 12C, together with a mount and an inlet chamber therefor configured to couple to the pump and conduit of FIG. 13;

FIG. 15 is a side, bottom perspective view of the diffuser thereof shown in isolation;

FIG. 16 is a bottom plan view thereof;

FIG. 17 is an enlarged bottom, side perspective of the diffuser thereof shown in fragment, with the diffuser including a gas injection hub having a plurality of circumferentially spaced-apart gas injection ports, together with a plurality of circumferentially spaced-apart and axially-extending passageways including axial intensifiers aligning with respective ones of said ports;

FIG. 18 is a bottom, side perspective view of the diffuser thereof, with the lower housing portion being removed to fully reveal the expansion chambers and radially-extending passageways thereof, with each said radially-extending passageway including a radial intensifier; and

FIG. 19 is a partially schematic, sectional elevation view taken along lines 18-18 of the diffuser of FIG. 15 to reveal one said axially-extending passageway including axial intensifier, together with one said radially-extending passageway including radial intensifier and a corresponding said expansion chamber extending therebetween.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

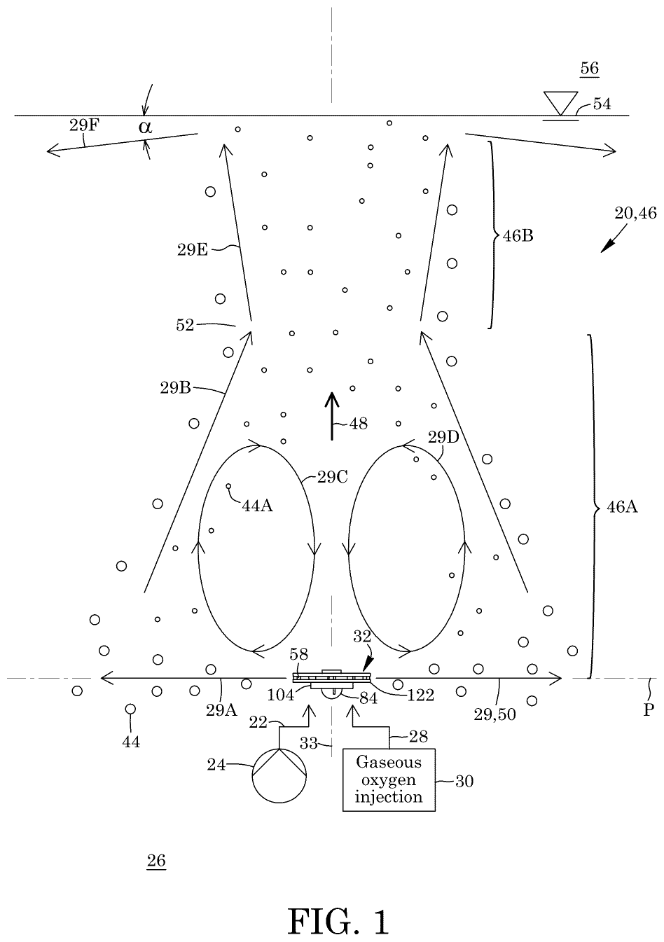

Referring to the drawings and first to FIG. 1, there is shown an oxygenation assembly 20. The oxygenation assembly includes a pressurized water stream 22, in this non-limiting embodiment provided via a pump 24. The pump is a submersible water pump in this example positioned within a body of water 26 and configured to pump water therefrom at a depth. The water may be referred to as ambient bulk water. The body of water 26 is an open body of water in this non-limiting embodiment and may comprise the ocean or a sea thereof, for example.

Oxygenation assembly 20 includes or is connectable to a pressurized oxygen-enriched gas stream 28. The oxygen-enriched gas stream comprises an oxygen-containing gas and/or a pressurized concentrated gaseous oxygen, in this non-limiting embodiment provided via an oxygen gas supply 30. The oxygen gas supply may be in the form of an oxygen injector. However, this is not strictly required and pressurized oxygen may be supplied through other means in other examples, such as via a pressurized oxygen tank, an oxygen generator/compressor or the like. In one non-limiting example, the oxygen may be supplied via an aquaculture assembly and/or oxygen concentrator such as that described in International (PCT) Patent Application No. PCT/CA2023/050932 filed in the Canadian Receiving Office of the World Intellectual Property Office on 11 Jul. 2023, and the disclosure of which is incorporated herein by reference. The oxygen need not necessarily comprise high purity oxygen gas. The term “gaseous oxygen” is intended to encompass injected gas comprising oxygen anywhere in the range of equal to or greater than that found in air, to high purity oxygen gas.

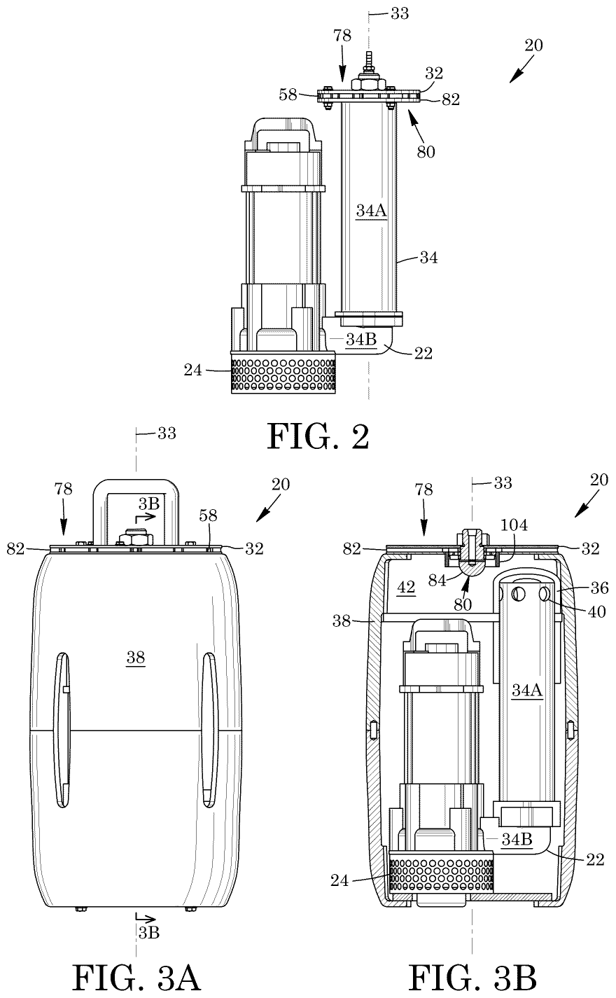

Oxygenation assembly 20 includes a diffuser, in this non-limiting embodiment an aquaculture diffuser 32. The diffuser extends about a longitudinal axis, in this non-limiting example a vertical axis 33 when in use. Axis 33 may also be referred to as the longitudinal axis of oxygenation assembly 20. Diffuser 32 is configured to be transportable and/or selectively deployable in this non-limiting embodiment; however, this is not strictly required. The diffuser is configured to receive water or pressurized water stream 22 from pump 24. As seen in FIG. 2, oxygenation assembly 20 includes in this non-limiting example a conduit 34 via which the pump and diffuser 32 operatively connect. In this non-limiting embodiment, the conduit includes a first portion 34A that is coaxial with and extends downwards from the diffuser and a second portion 34B which extends radially/laterally outwards to pump 24; however, this is not strictly required.

In addition or alternatively and referring to FIGS. 3A and 3B, oxygenation assembly 20 may include a manifold or manifold assembly 36 via which pump 24 and the diffuser operatively connect. The oxygenation assembly includes a housing 38 within which the manifold assembly is enclosed in this non-limiting example. The housing is cylindrical in outer shape in this example. Housing 38 is coaxial with diffuser 32 and axis 33 thereof in this example. The housing couples to and extends downwards from the diffuser. Conduit 34 includes a plurality of circumferentially spaced-apart apertures 40 extending therethrough and in fluid communication with the bottom of diffuser 32 via a chamber 42 seen in FIG. 3B enclosed by the housing. The apertures and/or conduit may be said to be a part of manifold assembly 36. However, this is not strictly required and pressurized water may be directed to the diffuser in other manners in other embodiments.

Referring back to FIG. 1, diffuser 32 is configured to receive and mix together pressurized water or water stream 22 and pressurized concentrated oxygen gas or oxygen gas stream 28 so as to form a mixture 29 of gas bubbles and water. The diffuser is configured to process the gas bubble stream into small and/or fine bubbles 44 and disperse the bubbles so processed through the pumped water stream and into the body of water 26. Oxygen-containing gas 30 is thus diffused into the body of water via diffuser 32. The diffuser is configured to both distribute and process and/or promote-dissolution of oxygen within the body of water 26.

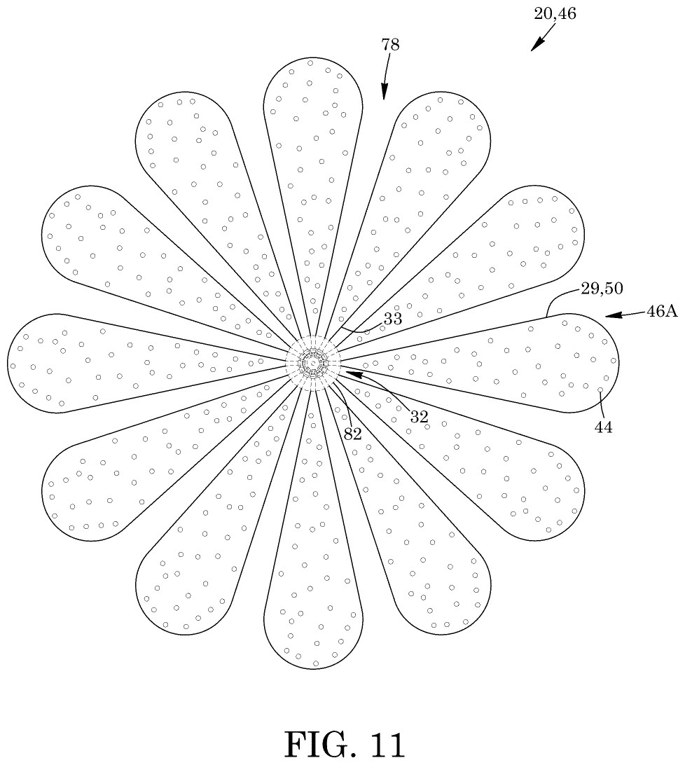

As seen in FIGS. 1 and 11, diffuser 32 is configured to circumferentially and radially disperse and/or jet away therefrom the water and gas stream so combined and processed. Referring back to FIG. 1, the diffuser is configured to direct mixture 29 of bubble-containing water radially and circumferentially outwards therefrom, as shown by arrows 29A, so as to form a bubble plume 46. The bubble plume includes a lower portion or first bubble plume portion 46A and an upper portion or second bubble plume portion 46B. The first and second bubble plume portions are coaxial with and extend along and about axis 33, which may be referred to as a plume axis.

First bubble plume portion 46A of bubble plume 46 tapers in an upward direction 48. The first bubble plume portion of the bubble plume is generally or substantially frustoconical in outer shape in this example. Diffuser 32 is configured such that the radial velocity of mixture 29 outwards from the diffuser is significant enough to inhibit upward velocity of water everywhere but at extremities of sprayed/dispersal zone 50. The diffuser is thus configured to provide a jet coverage which inhibits initial entrainment of mixture upwards for a predetermined or threshold amount of time and/or a predetermined or threshold radially-outwardly extending distance. This thereby promotes a prolonged contact time between bubbles 44 and the body of water 26. Mixture 29 so spread outwards promotes additional contact time between the bubbles and the body of water. The latter enables more oxygen to dissolve into the water. Diffuser 32 so configured to inhibit initial upward velocity of the mixture outputted therefrom, thereby promotes creation of a lower initial plume flow upwards, decreasing the total water flow upwards, and increasing dissolved oxygen (DO) concentration within the body of water adjacent thereto. Diffuser 32 so configured with said jet coverage which inhibits initial up flow of water, thereby reduces an initial plume rise velocity and enables the diffuser to be positioned at shallower and/or less depth compared to a conventional diffuser where bubbles are not first directed radially/circumferentially outwards and where contact time between bubbles and water may be dictated more/primarily by vertical movement of the bubbles upwards.

At the extremities of sprayed zone 50, mixture 29 begins rising (as shown by arrows 29B) and the inhibited upward velocity thereof induces a contraction 52 of bubble plume 46 above the diffuser. The contraction combined with circumferentially spaced radial jets or flow of mixture radially outwards (as shown by arrow 29A) form one or more and in this example a plurality of circumferentially spaced-apart recirculation zones 29C and 29D immediately above diffuser 32. The recirculation zones are enclosed within first bubble plume portion 46A of the diffuser. Recirculation zones 29C and 29D comprise outwardly positioned water continuously flowing radially outwards, then axially upwards, then radially inwards and then axially downwards once more towards the diffuser. The recirculation zones function to trap very small bubbles 44A and thereby enable, facilitate and/or promote additional contact time for the same. Diffuser 32 is thus configured to include radially spreading jets of high coverage, creating strong recirculation zones 29C and 29D thereabove which function to trap very small bubbles and thereby enable additional contact time for the small bubbles.

Still referring to FIG. 1, second bubble plume portion 46B of bubble plume 46 is above first bubble plume portion 46A and recirculation zones 29C and 29D in this example. The second bubble plume portion of the bubble plume is generally or substantially frustoconical in outer shape in this example. Second bubble plume portion 46B is a radially-outwardly extending and/or flares outwards in upward direction 48. Bubble plume 46 is thus shaped to flare outwards above one or more recirculation zones 29C and 29D. Diffuser 32 is therefore configured to promote formation of a bubble plume with first bubble plume portion 46A that tapers upwards and second bubble plume portion 46B that outwardly-flares upwards. The second bubble plume portion of bubble plume 46 may comprise a standard bubble plume and/or have a standard bubble plume formation above contraction 52. Gas dissolution continues in second bubble plume portion 46, entrainment of surrounding water occurs, the mixture rises (as shown by arrows 29E) to surface 54, the undissolved gas combines with atmosphere 56, and the treated water radially spreads at or adjacent the surface radially/laterally outwards from and/or away from bubble plume 46 and mixes with bulk water 26. This is shown by arrows 29F. This mixture of water of increased oxygen content may thus extend laterally/radially outwards in part and downwards in part from the perspective of FIG. 1 at an acute angle α relative to the surface.

There may thus be provided a method of diffusing and/or dissolving gas bubbles 44 in water 26 via diffuser 32. The method includes jetting mixture 29 of bubble-containing water radially and circumferentially outwards as seen by arrows 29A so as to form bubble plume 46, including in this example first bubble plume portion 46A thereof that tapers in upward direction 48. The method includes entraining water adjacent thereto via the jetting so as to form circumferentially spaced-apart recirculation zones 29C and 29D comprising rising water flowing radially outwards, axially upwards, radially inwards and then axially downwards towards diffuser 32 once more. The method may include causing bubble plume 46 to taper inwards via the recirculation zones and/or so as to form second bubble plume portion 46B that flares outwards in upward direction 48 thereafter.

There may also be provided a method of forming bubble plume 46 with a prolonged contact time between gas bubbles 44 and the body of water 26 to which the bubbles are dispersed. The method may include jetting radially and circumferentially outwards mixture 29 of gas bubbles and water via diffuser 32 at a velocity sufficient to i) inhibit initial entrainment of the mixture upwards, thereby promoting a prolonged contact time between the bubbles and the body of water; and ii) promote entrainment exterior to the diffuser, and thereby increasing water flow in the jetting, decreasing gas holdup within the diffuser, and inhibiting bubble coalescence. The method may include configuring the diffuser to output the mixture of the gas bubbles and water at a velocity sufficient to initially inhibit entrainment of the mixture upwards for a predetermined or threshold amount of time and/or for a predetermined or threshold radially-outwardly extending distance. Oxygenated water rises to the surface where the bubbles and plume water decouple, with the remaining gas joining atmosphere 56. The water at or adjacent surface 54 spreads radially away (seen by arrows 29F) from primary rising axis 33 of bubble plume 46, where the water returns to bulk water body 26. Oxygen or oxygen-containing gas bubbles 44 are configured to continually undergo mass transfer from a gaseous phase to dissolved oxygen (DO), raising the DO concentration of the water within and/or adjacent to the bubble plume. The following is a non-limiting embodiment of diffuser 32 which achieves the above functionality.

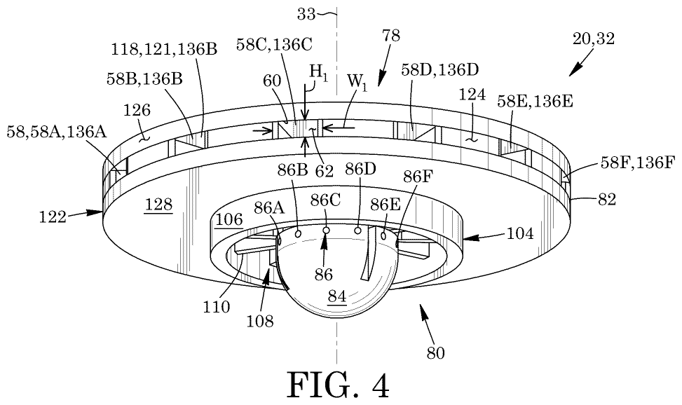

As seen in FIG. 4, the diffuser includes a plurality of circumferentially spaced-apart distal openings, in this example outlets, in this case outlet jets 58, as shown in the non-limiting embodiment of FIG. 4 by outlet jets 58A, 58B, 58C, 58D, 58E, 58F, 58G, 58H, 58I, 58J, 58K and 58L via which the mixture of water and gas bubbles is ejected. This number of outlet jets is not strictly required and there may be more or fewer outlet jets in other embodiments. Outlet jets 58 are radially outwardly-facing. The outlet jets are radially outwardly spaced from axis 33. Outlet jets 58 are configured to be high velocity outlet jets in this example. Referring to FIG. 1, the outlet jets are configured to direct mixture 29 of gas bubbles 44 and water substantially about and radially outwards from diffuser 32. Outlet jets 58 align within a plane P, in this example a horizontal plane when in use. Diffuser 32 is shaped to radially outwardly spread mixture 29 on the horizontal plane away therefrom.

Each outlet jet 58 is shaped to promote entrainment and/or inhibit gas holdup and/or bubble coalescence. The outlet jets are thus shaped to direct bubble-dispersed water outwards so as to promote entrainment with adjacent water exterior to diffuser 32. Referring to FIG. 4, each outlet jet 58 is non-square and non-circular in lateral or cross-section in this example. Each outlet jet is rectangular in lateral section in this example. Each outlet jet 58C has a cross-sectional width W₁ (tangentially-extending and/or extending tangential to axis 33) that is greater than that of a cross-sectional height H₁ (extending parallel to axis 33) thereof. Each outlet jet 58C has an inner circumference 60 (comprising 2×W₁+2×H₁) and a cross-sectional area 62 (comprising W₁×H₁), with the inner circumference to cross-sectional area ratio being greater than that of a circle and/or square in this example. The higher circumference to area ratio may increase radial jet entrainment after leaving diffuser 32. Increased entrainment may promote increased water flow in the outlet jet. This may decrease gas holdup, thereby inhibiting bubble coalescence. Outlet jets 58 are thus shaped to promote entrainment exterior to diffuser 32, and thereby increase water flow in the jet, decrease gas holdup within the diffuser, and inhibit bubble coalescence.

Referring to FIG. 1 and in addition and/or separately from the above, there is also provided herein an improved said diffuser 32 which may better promote mixing of and/or dissolving oxygen-containing gas bubbles 44 within water 26.

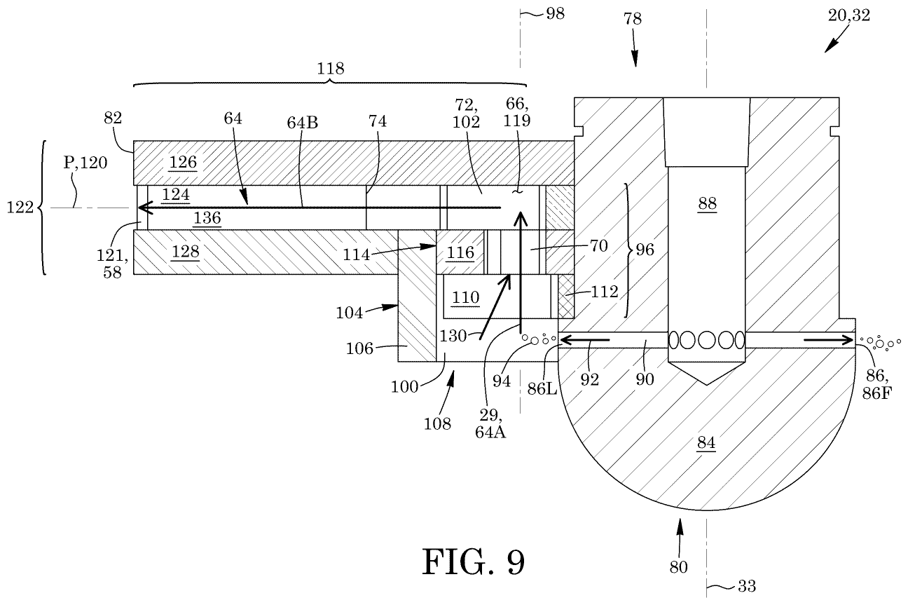

As seen in FIG. 9, the diffuser is configured to promote and/or provide one or more flow paths 64 of oxygen-injected water which move axially upwards (as schematically shown by arrow 64A) and then radially-outwards (as schematically shown by arrow 64B). Diffuser 32 is configured to primarily break-up bubbles in the axial-radial transition 66 in the flow paths. The diffuser may thus be configured to primarily break up bubbles in the transition of oxygen-injected said water being directed from axially upwards to radially outwards.

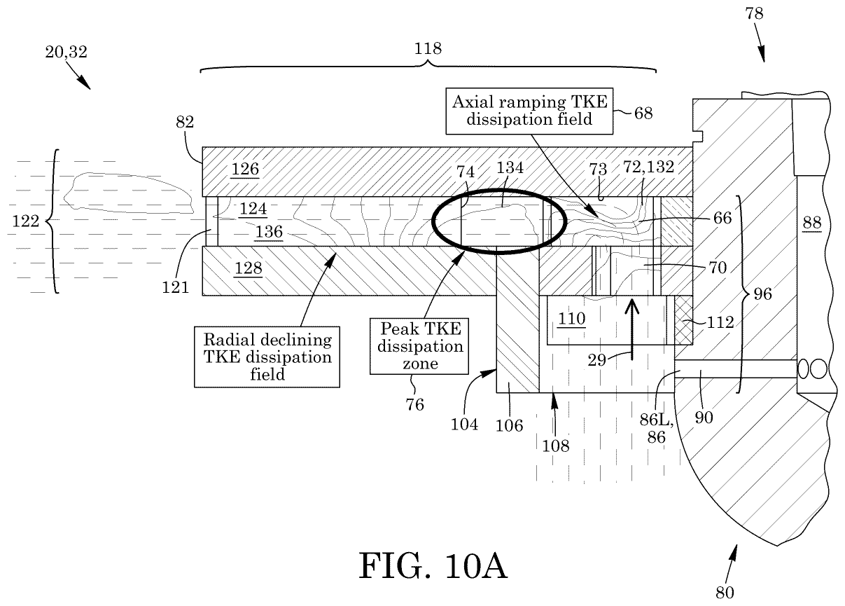

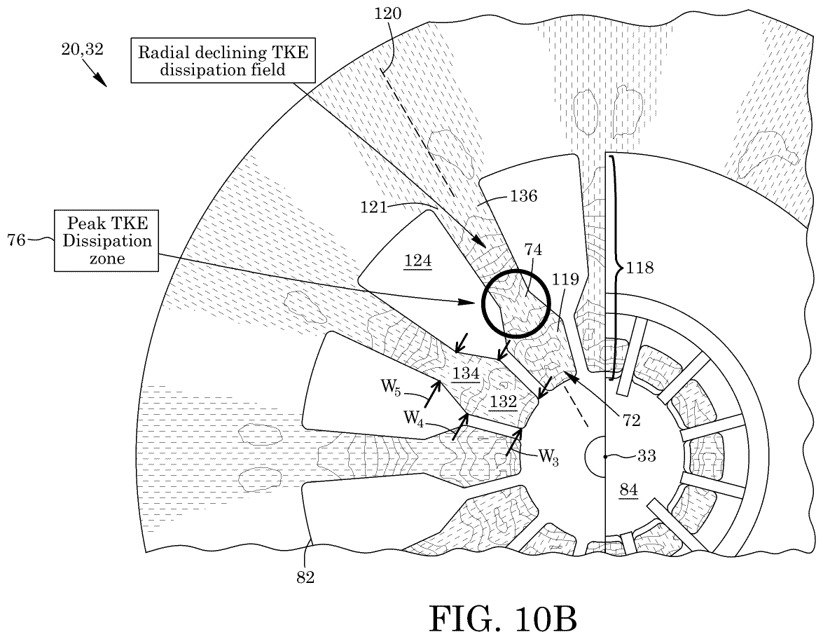

Referring now to FIG. 10A, diffuser 32 is further configured to induce a homogeneous ramping turbulent kinetic energy (TKE) dissipation field 68, which results in gas bubble breakage and with mixing thereof increasing with the strength of the turbulent kinetic energy (TKE) dissipation field. The diffuser may promote the creation of such fields via one or more constrictions, axially-extending intensifiers or axial intensifiers 70, one or more expansion chambers 72 downstream thereof and/or one or more constrictions, radially-extending intensifiers or radial intensifiers 74 further downstream thereof. The combined expansion and direction change from axial to radial flow may thus induce homogeneous said ramping turbulent kinetic energy (TKE) dissipation fields 68, which may result in gas bubble breakage with mixing thereof increasing with the strength of the turbulent kinetic energy (TKE) dissipation field. Radial intensifiers 74 are shaped to promote a peak said turbulent kinetic energy (TKE) dissipation field (or zone) 76 adjacent thereto. The following is a non-limiting embodiment which achieves the above functionality.

As seen in FIG. 4, diffuser 32 is substantially cylindrical in outer shape in this non-limiting embodiment; however, this is not strictly required. The diffuser has a top 78, bottom 80 and an annular periphery 82 extending between the top and the bottom thereof. The top and bottom of diffuser 32 are circular in this non-limiting example. Outlet jets 58 are positioned about and adjacent the annular periphery of the diffuser. Longitudinal axis 33 of diffuser 32 extends through top 78 and bottom 80 of the diffuser in this example.

Still referring to FIG. 4, the diffuser includes a first member, in this example a gas injection housing or module, in this case a gas injection hub 84. The gas injection hub extends from bottom 80 towards top 78 of diffuser 32 in this non-limiting example. Diffuser 32 includes a plurality of circumferentially spaced-apart gas injection ports 86, as shown in FIG. 4 in this non-limiting embodiment by ports 86A, 86B, 86C, 86D, 86E and 86F. There may be additional or fewer ports in other embodiments.

As seen in FIG. 9, gas injection hub 84 in this non-limiting example has a first or central bore 88 coaxial with axis 33 and in fluid communication with each gas injection port 86 via laterally/radially outwardly extending and circumferentially spaced-apart bores 90. The central bore of the gas injection hub may be referred to as an interior of the gas injection hub, with each gas injection port thus extending into and being in fluid communication with the interior of the hub. Central bore 88 of gas injection hub 84 operatively connects to and/or is selectively in communication with oxygen-containing gas supply 30 seen in FIG. 1. Gas injection hub 84 is thus shaped to receive and be in selective fluid communication with the oxygen-containing gas supply. Gaseous oxygen or oxygen-containing gas is therefore outputted from ports 86 seen in FIG. 4. The above arrangement is not strictly required and oxygen-containing gas may be directed to diffuser 32 in other manners in other embodiments.

Gas injection hub 84 is centrally located and coaxial with longitudinal axis 33 thereof in this non-limiting example. The gas injection hub is outwardly convex in this non-limiting embodiment in a downward facing direction. Gas injection hub 84 is hemispherical in shape in this non-limiting example. The gas injection hub is shaped to inhibit pressure loss and may be referred to as a spherical snubber at the bottom thereof. As seen in FIG. 9, gas injection ports 86 are positioned to be subject to a continuous crossflow 64A of water. Gas injection hub 84 is shaped to position the gas injection ports tangential to the flow of water. The water crossflow may occur naturally with minimal and/or substantially-zero/no associated pressure loss. Gas injection hub 84 is shaped such that axial flow 64A of water thereover creates a liquid shear over each gas injection port 86 and which inhibits formation of enlarged bubbles outwards from or adjacent the ports. Gas 92 outputted from injection ports 86L forms an initial bubble distribution 94 concentrated adjacent the gas injection hub.

Referring to FIG. 6, diffuser 32 includes at least one and in this example a first plurality of circumferentially spaced-apart passageways configured to direct oxygen-injected water axially upwards: in this non-limiting embodiment said plurality of circumferentially spaced-apart and axially-extending passageways 96 as seen in FIG. 6 in this non-limiting embodiment by axially-extending passageways 96A, 96B, 96C, 96D, 96E, 96F, 96G, 96H, 96I, 96J, 96K and 96L. There may be fewer or additional axially-extending passageways in other embodiments. Each axially-extending passageway aligns with a respective one of the gas injection ports 86: this is seen in FIG. 6 by axially-extending passageways 96B and 96C aligning with ports 86B and 86C, respectively. The axially-extending passageways axially align with respective gas injection ports in this example. Referring to FIG. 9, each axially-extending passageway 96 is elongate and may be referred to as a first elongate passageway. Each axially-extending passageway extends along a first or longitudinal axis 98 which in this example is parallel to and radially outwardly spaced from longitudinal axis 33 of diffuser 32.

Still referring to FIG. 9, each axially-extending passageway 96 has a proximal end portion 100, a distal end portion 102 spaced-apart therefrom and a constriction, in this example axially-extending intensifier or axial intensifier 70. Diffuser 32 may thus be said to include at least one and in this example a plurality of circumferentially spaced-apart and axially-extending intensifiers or axial intensifiers. The axial intensifiers may be referred to as axial intensifier elements. Each axially-extending passageway 96 is shaped to receive mixture 29 of gas bubbles 94 and water therethrough and may be configured to produce a first venturi effect thereon. Referring to FIG. 10A, axial intensifiers 70 are shaped to increase the velocity and turbulent kinetic energy (TKE) of the mixture of water and gas bubbles dispersed therewithin, with immediate dissipation of which thereafter inducing breaking of said gas bubbles down to smaller sizes. The following is a non-limiting embodiment of a structure which achieves the above functionality.

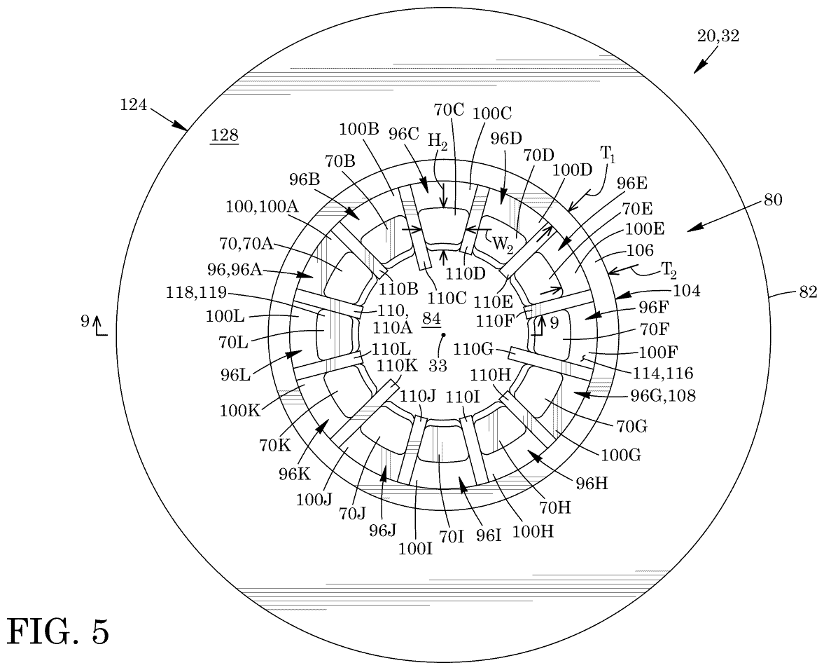

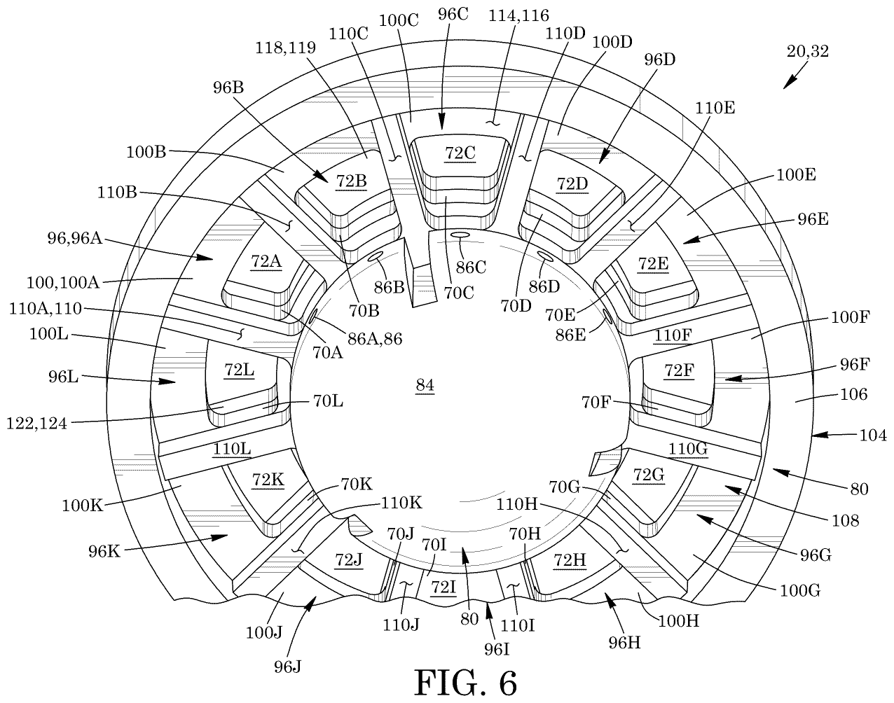

As seen in FIG. 4, diffuser 32 in this example includes a second member, in this case annular member 104. The annular member is shaped to enable/facilitate passage of water and bubbles axially therethrough. Annular member 104 is cylindrical in outer shape in this example and may be referred to as a lower portion of the diffuser. The annular member in this non-limiting example includes a peripheral portion 106 which is annular and may be referred to as an annular peripheral portion. Annular member 104, including the peripheral portion thereof, are radially inwardly spaced from annular periphery 82 of diffuser 32 in this example. As seen in FIG. 5, peripheral portion 106 of the annular member has a thickness T₁ which is radially-extending in this example. Annular member 104, including the peripheral portion thereof, are coaxial with and extend about axis 33 of diffuser 32 in this non-limiting embodiment. As seen in FIG. 9, the annular member is positioned between top 78 and bottom 80 of the diffuser in this non-limiting embodiment. Annular member 104 has an open bottom 108 in this non-limiting example via or adjacent to which mixture 29 of gas bubbles and water is received.

Referring to FIG. 6, the annular member has a plurality of circumferentially spaced and axially-extending openings extending therethrough which in this example correspond and thus may be referred to as proximal end portions 100 of axially-extending passageways 96. The proximal end portions of annular member 104 align with respective ports 86. As seen in FIG. 5, each proximal end portion 100 of the annular member is an annular sector in top/bottom profile in this non-limiting embodiment; however, this is not strictly required. The proximal end portions of annular member 104 are radially inwardly spaced from peripheral portion 106 of the annular member in this example.

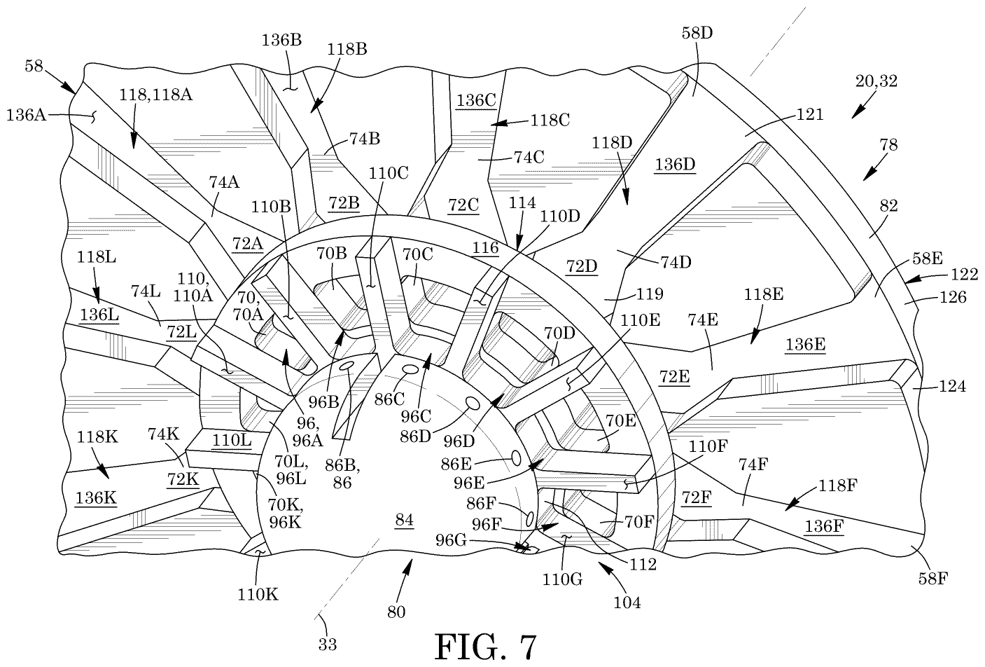

As seen in FIG. 6, annular member 104 includes in this non-limiting embodiment a plurality of circumferentially spaced-apart and radially outwardly-extending elongate portions 110A, 110B, 110C, 110D, 110E, 110F, 110G, 110H, 110I, 110J 110K and 110L. There may be more or fewer elongate portions in other embodiments. Elongate portions 110 may be referred to as dividing members. Each elongate portion is a rectangular prism in shape in this example; however, this is not strictly required. As seen in FIG. 5, elongate portions 110 of annular member 104 operatively connect to and extend radially inwards from peripheral portion 106 of the annular member. Referring to FIG. 7, the annular member includes an inner or central portion, in this non-limiting example a channel splitting plate 112 of which the elongate portions are a part thereof. The channel splitting plate is radially inwardly spaced from the peripheral portion of annular member 104.

As seen with reference to FIGS. 7 and 9, elongate portions 110 are shaped to divide incoming axial water flow 64A and bubbles 94 into multiple mixing channels or axially-extending passageways 96, with proximal end portions 100 of the axially-extending passageways being positioned between respective pairs of elongate portions: this is seen in FIG. 5 by proximal end portion 100A positioned between elongate portions 110A and 110B. The proximal end portions of the axially-extending passageways are further defined by and positioned between radially aligned segments of peripheral portion 106 of annular member 104 and channel splitting plate 112: this is seen in FIG. 9. Each proximal end portion 100 of the axially-extending passageways may thus be referred to a gas-liquid mixing chamber adjacent and/or formed by annular member 104 in this non-limiting embodiment.

As seen in FIG. 6, diffuser 32 in this non-limiting embodiment includes a third member, in this example an axially-constricting member 114 operatively connected to and positioned above annular member 104 thereof. The axially-constricting member is annular at least in part in this non-limiting example; however, this is not strictly required. As seen in FIG. 7, axially-constricting member 114 is coaxial with and extends about axis 33 of diffuser 32.

Axially-constricting member 114 has a plurality of circumferentially spaced-apart openings, in this example constrictions, in this case axially-extending intensifier or axial intensifiers 70A, 70B, 70C, 70D, 70E, 70F, 70G, 70H, 70I, 70J, 70K and 70L. However, additional or fewer axial intensifiers may be provided in other embodiments. The axially-constricting member thus includes a plurality of circumferentially spaced-apart said axially-extending intensifiers or axial intensifiers. Axial intensifiers 70 are interposed between respective elongate portions 110 of annular member 104: this is seen by axial intensifier 70A positioned between elongate portions 110A and 110B of the annular member.

The axially-constricting member is plate shaped in this non-limiting example may be referred to as an axial intensifier plate. Axially-constricting member 114 includes in this non-limiting example a peripheral portion 116, which in this case is annular and thus may be referred to as an annular peripheral portion. As seen in FIG. 7, elongate portions 110 couple to the peripheral portion of the axially-constricting member in this example. Axially-constricting member 114 is generally and/or substantively coextensive with channel splitting plate 112 in this non-limiting embodiment. Axial intensifiers 70 are radially inwardly spaced from peripheral portion 116 of the axially-constricting member in this example; however, this is not strictly required.

As seen in FIG. 7, the peripheral portion of axially-constricting member 114 has a thickness T₂ which is radially-extending in this example. The thickness of peripheral portion 116 of the axially-constricting member is greater and extends radially inwards to a greater extent than thickness T₁ of peripheral portion 106 of annular member 104 in this example. Each axial intensifier 70 is an annular sector in top/bottom profile optionally with rounded corners in this non-limiting embodiment; however, this is not strictly required.

As seen in FIG. 5, axial intensifiers 70 are of smaller cross-sectional area compared to proximal end portions 100 of axially-extending passageways 96. Each axial intensifier has a cross-sectional width W₂ and a height H₂. Referring to FIG. 9, each axially-extending passageway 96 is shaped via its axial intensifier 70 to cause mixture 29 of gas bubbles 94 and water to undergo a first acceleration and/or increased velocity in an axial direction (shown by numeral 64A). Each axial intensifier is smaller cross-sectional area compared to corresponding proximal end portion 100 and distal end portion 102 of axially-extending passageway 96. Each axially-extending passageway 96 thus has a reduced cross-sectional area between proximal and distal end portions thereof.

As seen in FIG. 5, the axially-extending passageways extend laterally from hub 84 to annular member 104 in this example. Each axially-extending passageway 96A is wider/widest adjacent annular member 104 in this example. Each axially-extending passageway laterally tapers and/or narrows radially inwards from the annular member to/towards hub 84. Each axially-extending passageway 96A may thus be said to laterally flare outwards relative a respective/adjacent gas injection port 86A seen in FIG. 4.

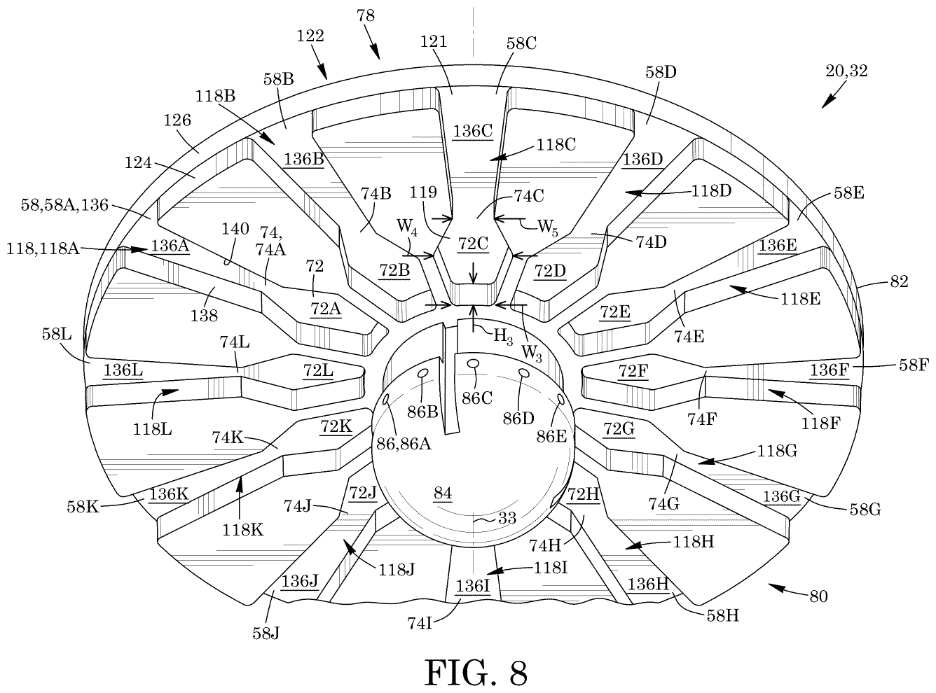

Referring now to FIG. 8, diffuser 32 includes at least one and in this example a second plurality of circumferentially spaced-apart passageways configured to re-direct the oxygen-injected said water radially outwards: in this non-limiting embodiment a plurality of circumferentially spaced-apart and radially outwardly-extending passageways 118A, 118B, 118C, 118D, 118E, 118F, 118G, 118H, 118I, 118J, 118K and 118L. There may be additional or fewer radially-extending passageways in other embodiments. As seen in FIG. 9, each radially-extending passageway is in fluid communication with and is downstream of a corresponding said axially-extending passageway 96. Referring back to FIG. 8, the radially-extending passageways are each in fluid communication with and downstream of a respective one of the oxygen injection ports: this is seen by radially-extending passageway 118C being in fluid communication with and downstream of oxygen injection port 86C. The radially-extending passageways axially align with respective ports and axially-extending passageways in this non-limiting embodiment. Referring to FIG. 10A, each radially-extending passageway 118 is configured to increase the prevailing turbulent kinetic energy (TKE) dissipation level of mixture 29 (as shown by numeral 68) and create a highest turbulent kinetic energy (TKE) dissipation level (as shown by numeral 76) via which the gas bubbles are processed down to one or more final sizes. The following is a non-limiting embodiment which achieves this functionality.

Referring to FIG. 9, each radially-extending passageway 118 is elongate and may be referred to as a second elongate passageway. Each radially-extending passageway extends along a second or longitudinal axis 120 which in this example is perpendicular to longitudinal axis 98 of corresponding axially-extending passageway 96. Referring to FIGS. 5, 8 and 9, each radially-extending passageway 118 is wider in lateral cross-section than that of its corresponding axially-extending passageway in this example. As seen in FIG. 8, each radially-extending passageway is rectangular in lateral cross-section in this non-limiting embodiment.

Diffuser 32 includes in this non-limiting embodiment a fourth member, in this example a radially-extending member 122 via which radially-extending passageways 118A, 118B, 118C, 118D, 118E, 118F, 118G, 118H, 118I, 118J, 118K and 118L are formed in part and through which the radially-extending passageways extend. Radially-extending member 122 is coaxial with and extends about axis 33 of diffuser 32 in this example. As seen in FIG. 9, the radially-extending member is annular in this non-limiting example and shaped to extend about and couple to hub 84; however, this is not strictly required. Referring to FIG. 7, annular member 104, axially-constricting member 114 and radially-extending member 122 may thus be referred to as first, second and third annular members in this example. As seen in FIG. 4, the radially-extending member extends from adjacent top 78 of the diffuser towards bottom 80 of the diffuser. Radially-extending member 122 may be referred to as an upper portion of diffuser 32. The radially-extending member is generally cylindrical and/or disc-shaped in this non-limiting embodiment.

Radially-extending member 122 aligns with and extends radially inwards from annular periphery 82 of diffuser 32 in this example. As seen in FIG. 7, the radially-extending member is larger in extent and/or extends radially outwards from hub 84, annular member 104 and/or axially-constricting member 114. The annular member, axially-constricting member and radially-extending member are planar in this non-limiting embodiment. Referring back to FIG. 7, hub 84, annular member 104, axially-constricting member 114 and radially-extending member 122 as herein described/shown comprises a non-limiting embodiment and the hub, annular member, axially-constricting member and radially-extending member or any combination thereof, may be integrally connected together so as to form a unitary whole in other embodiments.

The radially-extending member in this non-limiting embodiment comprises: a first or middle portion, in this example a radial intensifier plate 124 seen in FIG. 8 and through which radially-extending channels 118 extend; a second or upper planar portion, in this non-limiting example an upper plate 126; and a third or lower planar portion, in this non-limiting example a lower plate 128 seen in FIG. 4. Alternatively, plates 124, 126 and/or 128 may be integrally coupled together so as to form a unitary whole. Radial intensifier plate 124 is positioned between, couples to and is coextensive with the upper and lower plates in this non-limiting embodiment. As seen in FIG. 8, upper plate 126 is circular in shape in this non-limiting embodiment. Referring to FIGS. 4 and 9, lower plate 128 is annular in this non-limiting example. As seen in FIG. 9, the lower plate is shaped to extend about and couple to peripheral portion 116 of axially-constricting member 114 in this non-limiting embodiment.

Referring to FIG. 8, diffuser 32 may thus comprise a plurality of circumferentially spaced-apart and radially outwardly extending expansion chambers 72A, 72B, 72C, 72D, 72E, 72F, 72G, 72H, 72I, 72J, 72K and 72L. Alternatively, there may be fewer or more expansion chambers in other embodiments. In this non-limiting embodiment, each radially-extending passageway 118 includes an expansion chamber 72 at a proximal end portion 119 thereof. Each expansion chamber may thus be referred to as comprising or being a part of the proximal end portion of its corresponding radially-extending passageway. Alternatively and referring to FIG. 9, expansion chambers 72 may be referred to as part of and/or distal end portions 102 of axially-extending passageways 96. Each axially-extending passageway is in fluid communication with a respective radially-extending passageway 118 via a corresponding said expansion chamber. The expansion chambers may thus be said to be downstream of corresponding axially-extending passageways 96 at least in part and upstream of corresponding radially-extending passageways 118 at least in part.

Each expansion chamber 72 may thus be at distal end portion 102 of its corresponding axially-extending passageway. In addition or as a further alternative, the expansion chambers may be referred to as part of and/or proximal end portions 119 of radially-extending passageways 118. Each expansion chamber 72 axially aligns with a respective axial intensifier 70 and oxygen injection port 86 in this non-limiting embodiment. As seen in FIG. 6, each expansion chamber extends between an adjacent pair of elongate portions 110 of annular member 104 from a top or bottom view perspective: this is seen by expansion chamber 72C extending between elongate portions 110C and 110D. As seen in FIG. 7, each expansion chamber 72 extends perpendicular to and radially outwards from a corresponding axially-extending passageway 96 including axial intensifier 70 thereof. As seen in FIG. 9, each axially-extending passageway may thus be shaped to direct flow radially inwards 130 at least in part from proximal end portion 100 thereof to axial intensifier 70 thereof and then radially outwards via corresponding expansion chamber 72. Mixture 29 of water and gas bubbles outputted from the axial intensifiers thus enter respective expansion chambers.

As seen in FIG. 8, each expansion chamber 72 has a height H₃ and one or more widths, in this non-limiting embodiment a minimum W₃ and a maximum width W₄. However, this is not strictly required and the expansion chambers may have a constant/fixed width in other embodiments. Taking into account either width W₃ or W₄, each expansion chamber 72 is this example is wider than height H₃ thereof. Each expansion chamber has one or more width to height ratios, with each of which being larger than that of its corresponding axial intensifier 70 seen in FIG. 5 in this example. The flow of mixture 29 of water and gas bubbles seen in FIG. 9 changes direction from an axial said flow into the expansion chamber to a radial said flow.

As seen in FIG. 10B, each expansion chamber 72 in this non-limiting embodiment has a first portion or sub-chamber 132 with a width that expands/enlarges radially and/or outwardly flares, from minimum width W3 to maximum width W4 radially outwardly spaced therefrom. Each expansion chamber downstream of its corresponding axial intensifier 70 seen in FIG. 10A, is thus width-expanding in this example in a radially outward direction. First sub-chamber 132 is adjacent its corresponding axial intensifier. Each first sub-chamber is polygonal in shape, in this non-limiting example being an isosceles trapezoid in top/bottom profile in this non-limiting embodiment; however, this is not strictly required.

Referring back to FIG. 10B, each expansion chamber 72 in this non-limiting embodiment has a second portion or sub-chamber 134 operatively connected to, adjacent, in fluid communication with and downstream of first sub-chamber 132 thereof. As seen in FIG. 10A, each second sub-chamber extends radially outwards and/or is radially outwardly spaced from its corresponding axial intensifier 70. Referring back to FIG. 10B, each second sub-chamber has a width that contracts in a radially outwardly-extending direction. Each second sub-chamber 134 outwardly tapers in this non-limiting example. Each second sub-chamber is polygonal in shape, in this non-limiting example an isosceles trapezoid in top/bottom profile in this non-limiting embodiment; however, this is not strictly required. Each expansion chamber 72 is polygonal in top/bottom view and/or is a six-sided polygon or hexagon in shape in top/bottom view in this non-limiting embodiment, in this example being an elongate or irregular hexagon in shape; however, this is not strictly required.

As seen in FIG. 8, each radially-extending passageway 118A, 118B, 118C, 118D, 118E, 118F, 118G, 118H, 118I, 118J, 118K and 118L includes a constriction or radially-extending or radial intensifier 74A, 74B, 74C, 74D, 74E, 74F, 74G, 74H, 74I, 74J, 74K and 74L between proximal end portions 119 and distal end portions 121 thereof. Diffuser 32 thus includes a plurality of circumferentially spaced-apart and radially-extending constrictions/intensifiers or radial intensifiers in this example. Radial intensifiers 74 may be referred to as radial intensifier elements. Each radial intensifier has a width W₅ in lateral section which is less than that of maximum width W₄ of its corresponding expansion chamber 72. The width of each radial intensifier is also less than minimum width W₃ of its corresponding expansion chamber in this non-limiting embodiment; however, this is not strictly required. Referring to FIG. 8, each radially-extending passageway 118 (or radial intensifier 74 thereof) may have a height H₃ to width W₃/W₄/W₅ ratio in lateral section that is equal to or less than 1:2 in one non-limiting embodiment.

Each radial intensifier is smaller in cross-sectional area compared to corresponding proximal end portion 119 and distal end portion 121 of radially-extending passageway 118 in this non-limiting example. Each radially-extending passageway thus has a reduced cross-sectional area between proximal and distal end portions thereof.

Referring to FIG. 9, each radial intensifier 74 operatively connects to, aligns with, is in fluid communication with and/or is downstream of a respective said expansion chamber 72. Each radially-extending passageway 118 is thus downstream of its corresponding axially-extending passageway 96. Mixture 29 of water and gas bubbles exiting expansion chambers is directed to radial intensifiers 74. Each radially-extending passageway 118 is shaped via its radial intensifier 74 to cause the mixture of gas bubbles and water passing therethrough to undergo a second acceleration and/or increased velocity in a radially outwardly-extending direction 64B seen in FIG. 9. Each radial intensifier may thus be configured to produce a second venturi effect on the mixture of gas bubbles and water passing therethrough.

As seen in FIGS. 10A and 10B, each radial intensifier is configured to increase a prevailing turbulent kinetic energy (TKE) dissipation level 68 of expansion chamber 72 upstream thereof. Each radial intensifier 74 is configured to increase the prevailing turbulent kinetic energy (TKE) dissipation level in the expansion chamber. Each radial intensifier is configured to increase and/or maximize turbulent kinetic energy (TKE) dissipation levels 76. Each radial intensifier is configured to create a highest turbulent kinetic energy (TKE) dissipation level via which the gas bubbles are processed down to one or more final sizes.

As seen in FIG. 10B, each radially-extending passageway 118 is shaped at to direct flow laterally outwards in part (via its corresponding expansion chamber 72) and then laterally inwards (via radial intensifier 74 thereof) towards its longitudinal axis 120 at least in part.

Referring to FIG. 5, each axial intensifier 70 has a height H₂ to width W₂ ratio in lateral section that is greater than that of its corresponding radially-extending passageway and/or radial intensifier in this example. Each axial intensifier in lateral section has a height to width ratio in lateral section that may be up to two times or greater than that of its corresponding radially-extending passageway and/or radial intensifier in one non-limiting embodiment. Referring to FIG. 9, diffuser 32 may thus be said to comprise a plurality of circumferentially spaced-apart pathways shaped to reduce mixing length and improve and/or promote gas phase dispersion, with each pathway comprising an axially-extending portion or passageway 96 and a radially-extending portion or passageway 118 having a width greater than the axially-extending portion or passageway thereof. Diffuser 32 is configured to include one or more pathways thus shaped to undergo in lateral section lateral a height to width ratio change in transition 66 between axial and radial said flow. For each pathway, the transition from axially-extending passageway 96 of a first height in lateral section to radially-extending passageway 118 of a second height in lateral section which is less than said first height, may function to reduce mixing length and improve and/or promote gas phase dispersion.

Referring now to FIG. 8, radially-extending passageways 118 have distal openings or outlet jets 58A, 58B, 58C, 58D, 58E, 58F, 58G, 58H, 58I, 58J, 58K and 58L which are radially outwardly spaced from radial intensifiers 74A, 74B, 74C, 74D, 74E, 74F, 74G, 74H, 74I, 74J, 74K and 74L thereof, respectively. The outlet jets may correspond to or be said to comprise distal end portions 121 of radially-extending passageways 118. In addition or alternatively, outlet jets 58 may be said to be operatively connected to and in fluid communication with respective ones of radially-extending passageways.

Radially-extending passageways 118A, 118B, 118C, 118D, 118E, 118F, 118G, 118H, 118I, 118J, 118K and 118L include outer portions 136A, 136B, 136C, 136D, 136E, 136F, 136G, 136H, 136I, 136J, 136K and 136L, respectively. For each radially-extending passageway, the outer portion thereof is positioned and extends between corresponding radial intensifier 74 thereof and outlet jet 58 thereof. For each radially-extending passageway 118, outer portion 136 thereof includes a pair of circumferentially spaced and radially-extending walls: this is seen in FIG. 8 by walls 138 and 140 for outer portion 136A. Referring to FIG. 9, for each of radially-extending passageway, the outer portion thereof is shaped to promote attachment of mixture to walls thereof. Referring back to FIG. 8, for each radially-extending passageway 118, outer portion 136 thereof radially outwardly flares in this non-limiting example. Each outer portion is an isosceles trapezoid in top/bottom profile in this non-limiting embodiment; however, this is not strictly required. Referring back to FIG. 9, mixture 29 of water and gas bubbles so reduced in size exit radial intensifiers 74 and outer portions 136 of radially-extending passageways 118 and transit to outlet jets 58. The radially-extending passageways are thus arranged to promote radially spreading of oxygenated water away from diffuser 32 as seen by FIGS. 1 and 11.

In operation and referring to FIG. 9, axial intensifiers 70 may function to restrict and/or direct flow radially inwards (as seen by arrow 130) in part along axially-extending passageways 96 and this combined with an upward direction of axial flow 64A encourages gas bubbles 94 to fight against the movement forced by the velocity gradient, producing better mixing. Diffuser 32 is shaped to position the gas bubbles at a location of highest velocity and/or towards top 73 of expansion chamber 72 seen in FIG. 10A, which forces the bubbles to disperse throughout the water flow due to the large velocity gradient. This may thereby induce significant mixing and bubble break up in the expansion chamber. Transition 66 from axial to radial flow of mixture 29 functions as an initial bubble break up and disperses the gas bubbles well throughout the water flow. The axial-inflow and rapid expansion (due to expansion chambers 72) may function as an effective mixing chamber, inhibiting local hotspots of gas holdup. Momentum dissipation induced by the rapid direction transition of the mixture may promote creation of a well-mixed flow. Bubble buoyancy encourages the gas bubbles to fight against the movement forced by the velocity gradient, which may also produce improved mixing.

The width to height ratio change from axially-extending passageway 96 to radially-extending passageway 118, together with expansion chamber 72 positioned between the passageways and shaped to promote mixing of the mixture, may function to create a homogeneous turbulent kinetic energy (TKE) dissipation field 68. Diffuser 32 and/or radial intensifiers 74 thereof are shaped for each expansion chamber to induce said homogeneous ramping turbulent kinetic energy (TKE) dissipation field therein, with the homogeneity thereof promoting breaking of initial bubbles regardless of location.

Gas bubble breakage and mixing increases with the strength of the turbulent kinetic energy (TKE) dissipation field. Radial intensifiers 74 are shaped/positioned to promote a peak said turbulent kinetic energy (TKE) dissipation zone 76 adjacent thereto. Each radial intensifier is configured to create a stronger turbulent kinetic energy (TKE) dissipation field than that found in its corresponding expansion chamber 72, linearly ramping turbulent kinetic energy (TKE) dissipation as it transits corresponding axial intensifier 70.

Many advantages result from the structure of the present invention. For example and referring to FIG. 1, oxygenation assembly 20 and diffuser 32 thereof as herein described may comprise one or more improved performance metrics. Such metrics may include an improved ratio of oxygen processed per pump power (e.g., 10 LPM per 1 HP), as this may function to lower the power consumption required to process a given amount of input oxygen and on ocean-borne sites where electricity is unavailable, this is critically important. This may also include an improved ratio of oxygen input to pumped water input (e.g., 10 LPM oxygen to 100 US GPM water), which generally allows for smaller or fewer devices. This may further include an improved output bubble size of the nozzle/diffuser, with smaller bubbles dissolving into water faster than larger ones, enabling higher oxygen transfer efficiencies to the bulk water. Output bubble size may be a function of oxygen input and oxygenation assembly 20 (or diffuser 32 thereof) as herein described may hold a reasonably unchanging output bubble size over its rated gas input. Finally, the assembly and diffuser as herein described may result in an improved distribution pattern of the outputted gas-water mixture post-device: how the output gas-water mixture interacts with the water body. This dispersing of the mixture may thus inhibit bubble coalescence, which otherwise impacts the output bubble size.

Assembly 20 and diffuser 32 thereof as herein described may also result in a well-dispersed gas phase. This is advantageous as the more evenly distributed bubbles are throughout the water, the more gas may be processed per power and per water input.

Assembly 20 and diffuser 32 thereof as herein described may further result in and/or provide one or more homogeneous turbulent kinetic energy (TKE) dissipation fields 68 seen in FIG. 10A. This may be advantageous as the less concentrated is the energy dissipation, the more bubble breaking events can occur and the smaller the bubble size may be achieved. While bubble size achieved may be correlated to turbulent kinetic energy (TKE) dissipation, bubble breaking events take finite time. Assembly 20 and diffuser 32 thereof as herein described may be configured to provide or promote creation of one or more homogeneous turbulent kinetic energy (TKE) dissipation fields which are large enough for enough breaking events to occur to reach the intended target size for the bubbles. The assembly and diffuser thereof as herein described are configured to inhibit differing flow paths which may otherwise result in different turbulent kinetic energy (TKE) dissipation exposure and the desired bubble size thus not be achieved.

Assembly 20 and diffuser 32 thereof as herein described may result in an improved energy efficiency of the systems of the known prior art. This is because generating turbulent kinetic energy (TKE) dissipation inherently takes energy, representing a portion of the product of water flow rate and pressure drop. Assembly 20 and diffuser 32 thereof as herein described may be configured to inhibit/minimize energy loss where bubble breakage is not occurring, which may thereby function to promote/maximize/improve the energy efficiency thereof.

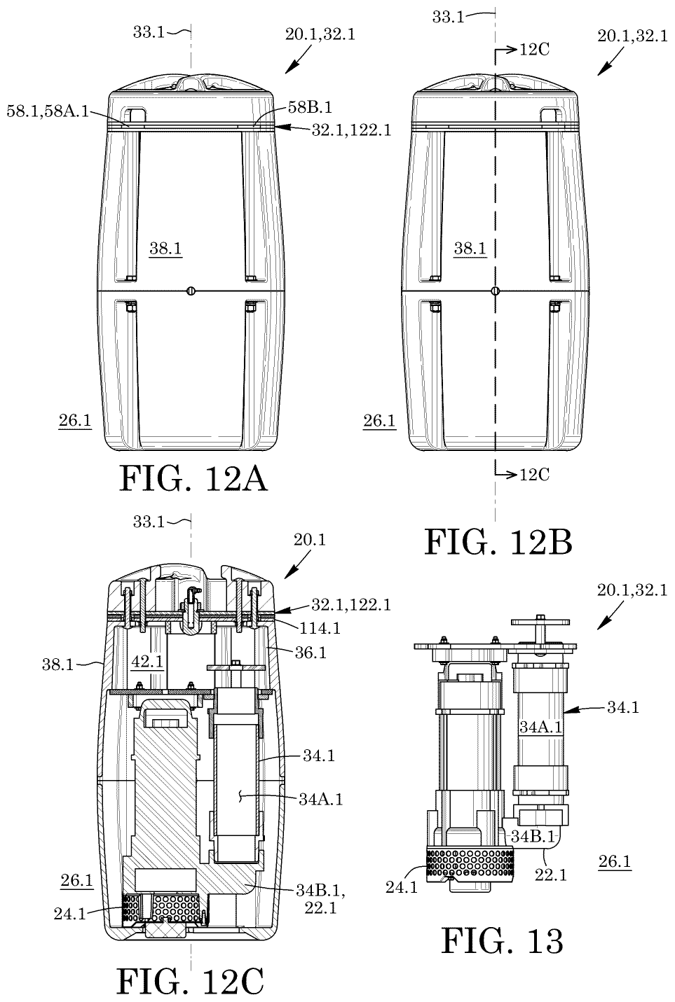

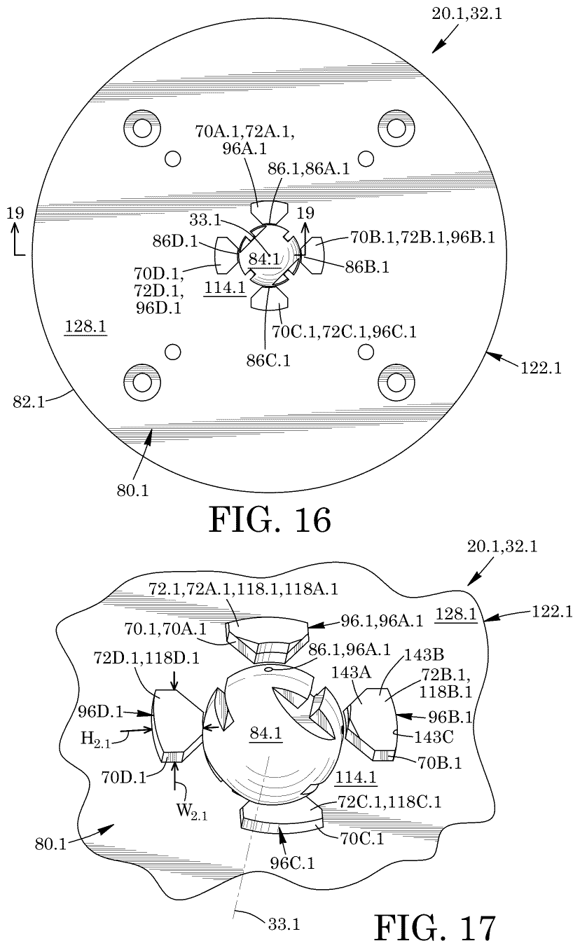

FIGS. 12A to 19 show oxygenation assembly 20.1 including diffuser 32.1 thereof according to another aspect. Like parts have like numbers and functions as oxygenation assembly 20 and diffuser 32 thereof shown in FIGS. 1 to 11 with the addition of decimal extension “0.1”. Oxygenation assembly 20.1 including diffuser 32.1 thereof are substantially the same as oxygenation assembly 20 and diffuser 32 thereof shown in FIGS. 1 to 11 with at least the following exceptions.

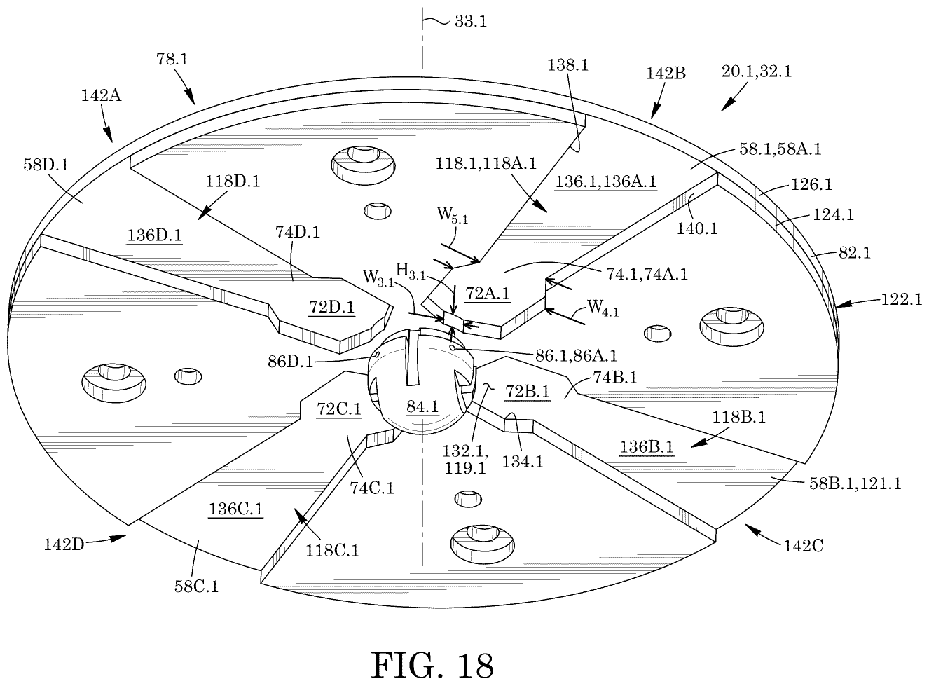

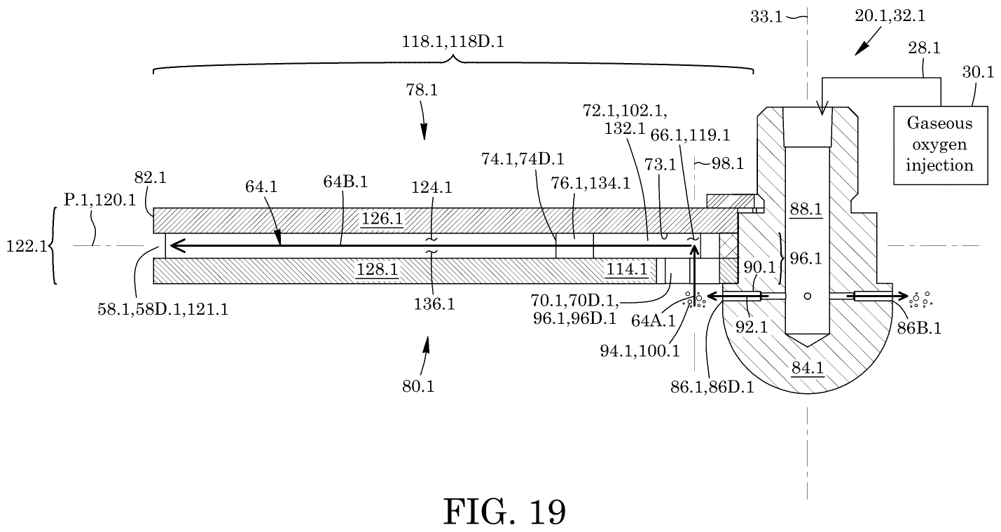

As seen with reference to FIGS. 18 and 19, diffuser 32.1 in this non-limiting embodiment includes one or more and in this non-limiting example one axially-extending passageway 96.1 and one radially-extending passageway 118.1 extending therethrough per quadrant 142A, 142B, 142C and 142D thereof. Referring to FIG. 19, the diffuser in this non-limiting example thus includes at least one axial constriction or intensifier 70.1 and at least one corresponding radial constriction or intensifier 74.1 per quadrant thereof. As seen in FIG. 17, diffuser 32.1 comprises four circumferentially spaced-apart and axially-extending passageways 96A.1, 96B.1, 96C.1 and 96D.1 in this non-limiting embodiment, each with its own axial intensifiers 70A.1, 70B.1, 70C.1 and 70D.1. However, this is not strictly required and there may be fewer or additional axially-extending passageways and/or axial intensifies per quadrant in other example.

Each axial intensifier 70B.1 includes a laterally-extending first or inner portion 143A which is polygonal in top/bottom profile, in this non-limiting example comprising an isosceles trapezoid in shape. Each axial intensifier includes a laterally-extending second or outer portion 143B which is generally rectangular in shape in top/bottom profile in this non-limiting embodiment. Each axial intensifier 70B.1 includes in this non-limiting example a radially outwardly positioned surface 143C which is curved and in this example outwardly concave.

As seen in FIG. 18, diffuser 32.1 comprises four circumferentially spaced-apart and radially outwardly-extending passageways 118A.1, 118B.1, 118C.1, and 118D.1 in this non-limiting embodiment, each with its own expansion chamber 72A.1, 72B.1, 72C.1 and 72D.1 and constriction or radially-extending or radial intensifier 74A.1, 74B.1, 74C.1, and 74D.1. However, this is not strictly required and there may be fewer or additional radially-extending passageways, expansions chambers and/or radial intensifies in other example. Radially-extending passageways 118A.1, 118B.1, 118C.1, and 118D.1 (including respectively expansion chambers 72A.1, 72B.1, 72C.1 and 72D.1, and radial intensifiers 74A.1, 74B.1, 74C.1 and 74D.1 thereof) are circumferentially spaced-apart from each other and extend about axis 33.1.

Each expansion chamber 72A.1 is an eight-sided polygon or octagon in top/bottom view in this non-limiting embodiment, in this example comprising an elongate or irregular octagon in shape; however, this is not strictly required. The first portion or sub-chamber 132.1 of each expansion chamber is hexagonal and/or an elongate and/or irregular hexagonal in top/bottom profile.

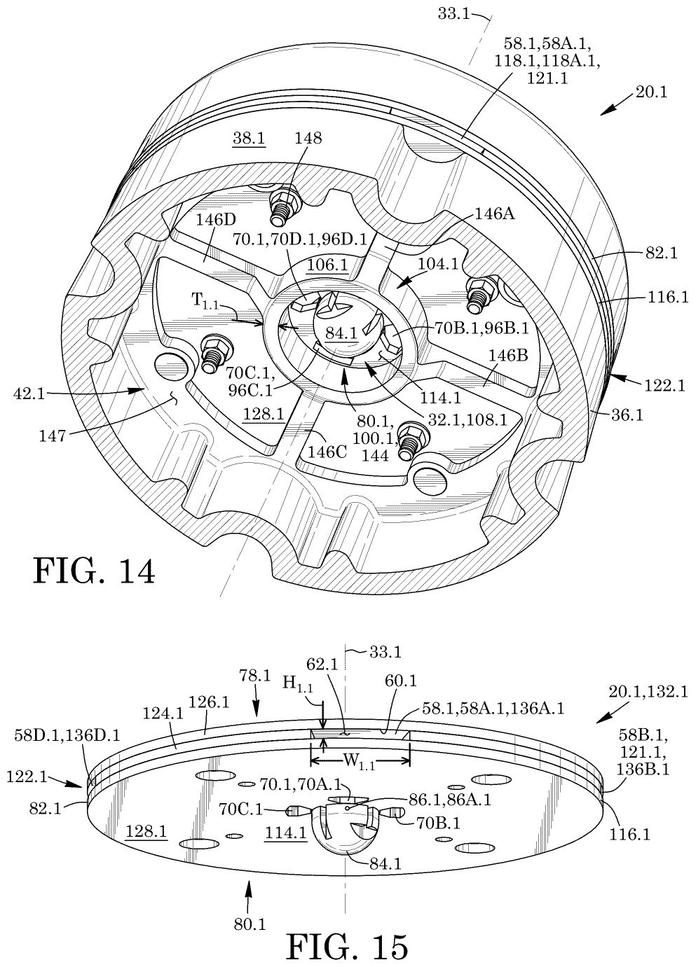

As seen in FIG. 14, each of axially-extending passageways 96A.1, 96B.1, 96C.1 and 96D.1 shares the same or a common proximal end portion 100.1. The proximal end portion of the axially-extending passageways comprises an enlarged annular space 144 which extends about hub 84.1 and/or gas injection ports 86. Proximal end portion 100.1 of axially-extending passageways 96A.1, 96B.1, 96C.1 and 96D.1 comprises, is enclosed by and/or is defined by a conduit or annular member 104.1.

The annular member is part of the mount or manifold assembly 36.1 in this non-limiting example. The manifold assembly and/or annular member thereof are configured to promote axial flow of water and gas bubbles towards axially-extending passageways 96A.1, 96B.1, 96C.1 and 96D.1. The following is a non-limiting embodiment which achieves this functionality. Annular member 104.1 is shaped to extend about and enclose the sides of the hub 84.1 as well being shaped to extend about gas injection ports 86.1 thereof seen in FIG. 14. The annular member seen in FIG. 14 encloses and extends downwards relative to gas injection hub 84.1 seen in FIG. 15 in this non-limiting embodiment. Referring back to FIG. 14, bottom 108.1 of annular member 104.1 is positioned downwards from that of hub 84.1 in this non-limiting embodiment.

The annular member in this non-limiting example is shaped to form a continuous annular opening or space 144. Annular member 104.1 does not in this non-limiting embodiment include the plurality of spaced-apart and radially outwardly-extending elongate portions 110 nor channel splitting plate 112 seen in FIG. 5 of annular member 104 of diffuser 32. As seen in FIG. 14, the annular member couples to housing 38.1 in this non-limiting embodiment via one or more and in this example four radially-extending and circumferentially spaced-apart elongate members or ribs 146A, 146B, 146C and 146D. The ribs are configured to provide structural support to diffuser 32.1, in this non-limiting example including aligning with corresponding radially-extending passageways 118A.1, 118B.1, 118C.1 and 118D.1 seen in FIG. 18. Ribs 146A, 146B, 146C and 146D extend from an annular outer member 147 adjacent periphery 82.1 of diffuser 32.1 towards axis 33.1 and hub 84.1 in this non-limiting example.

Diffuser 32.1 is selectively connectable to and removable from manifold assembly 36.1 thereof via fasteners 148 which extend through plate 128.1; however, this is not strictly required.

Still referring to FIG. 14, axially-constricting member 114.1 is in fluid communication with and directly couples to annular member 104.1 in this non-limiting example. As seen in FIG. 15, peripheral portion 116.1 of the axially-constricting member aligns and is co-extensive with periphery 82.1 of diffuser 32.1 in this non-limiting embodiment. Lower plate 128.1 and axially-constricting member 114.1 comprise the same part and/or are integrally connected together so as to form a unitary whole in this non-limiting embodiment. The axially-constricting member and radially-extending member 122.1 are co-extensive in this non-limiting example.

It will be appreciated that many variations are possible within the scope of the invention described herein. Where a component (e.g. an apparatus, assembly, device, member, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention. Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

### Additional Description

Examples of oxygenation assemblies and diffusers thereof, have been described. The following clauses are offered as further description.
(1) A diffuser via which oxygen-containing gas is diffused into a body of water, the diffuser comprising: a first plurality of circumferentially spaced-apart passageways configured to direct oxygen-injected said water axially upwards; and a second plurality of circumferentially spaced-apart passageways in fluid communication with respective ones of the first plurality of circumferentially spaced-apart passageways and configured to re-direct the oxygen-injected said water radially outwards.
(2) A diffuser according to any clause herein, wherein the diffuser is configured to primarily break up bubbles in the transition of oxygen-injected said water being directed from axially upwards to radially outwards.
(3) A diffuser via which oxygen-containing gas is diffused into a body of water, the diffuser comprising: a plurality of circumferentially spaced-apart gas injection ports; a plurality of circumferentially spaced-apart and axially-extending passageways each aligning with a respective one of said gas injection ports; and a plurality of circumferentially spaced-apart and radially outwardly-extending passageways each in fluid communication with a respective one of said axially-extending passageways.
(4) A diffuser according to any clause herein, wherein the diffuser is configured to promote a plurality of flow paths of oxygen-injected water which move axially upwards and then radially-outwards.
(5) A diffuser according to any clause herein, wherein the diffuser is configured to primarily break-up bubbles in the axial-radial transition in said flow paths.
(6) A diffuser according to any clause herein, wherein the radially outwardly-extending passageways have distal openings that are rectangular in lateral section.
(7) A diffuser according to any clause herein, wherein the radially outwardly-extending passageways have distal openings that are non-square and/or non-circular in lateral section.
(8) A diffuser according to any clause herein, wherein each said radially outwardly-extending passageway in lateral section has a height to width ratio that is less than that of each said axially-extending passageway.
(9) A diffuser according to any clause herein, wherein each said radially outwardly-extending passageway in lateral section has a height to width ratio in lateral section equal to or less than 1:2.
(10) A diffuser according to any clause herein, wherein each said axially-extending passageway in lateral section has a height to width ratio that is up two times than that of each said radially-extending passageway.
(11) A diffuser according to any clause herein, wherein each said axially-extending passageway in lateral section has a height to width ratio that is greater than two times than that of each said radially-extending passageway.
(12) A diffuser according to any clause herein, wherein the radially outwardly-extending passageways have distal openings shaped to direct bubble-dispersed water outwards so as to promote entrainment with adjacent water exterior to the diffuser.
(13) A diffuser according to any clause herein, wherein the radially outwardly-extending passageways have distal openings shaped to promote entrainment exterior to the diffuser, and thereby increasing water flow in the jet, decreasing gas holdup within the diffuser, and inhibiting bubble coalescence.
(14) A diffuser according to any clause herein, including a plurality of outlet jets operatively connected to respective ones of the radially outwardly-extending passageways, with each said outlet jet having an inner circumference to cross-sectional area ratio that is greater than that of a circle and/or square.
(15) A diffuser comprising: a plurality of circumferentially spaced-apart gas injection ports; a plurality of circumferentially spaced-apart and radially outwardly-extending passageways each in fluid communication with a respective one of said ports; and a plurality of outlet jets operatively connecting to respective ones of said passageways, with each said outlet jet being rectangular in cross-section and/or having a cross-sectional width that is greater than that of a cross-sectional height thereof.
(16) A diffuser via which oxygen-containing gas is diffused into a body of water, the diffuser comprising: a plurality of circumferentially spaced-apart gas injection ports; a plurality of circumferentially spaced-apart and radially outwardly-extending passageways each in fluid communication with a respective one of said ports; and a plurality of outlet jets operatively connected to respective ones of said passageways, with each said outlet jet having an inner circumference to cross-sectional area ratio that is greater than that of a circle and/or square.
(17) A diffuser according to any clause herein, wherein each said outlet jet is rectangular in lateral section.
(18) A diffuser according to any clause herein, wherein each said outlet jet is shaped to promote entrainment and/or inhibit gas holdup and/or bubble coalescence.
(19) A diffuser according to any clause herein, wherein the radially outwardly-extending passageways have distal openings that are rectangular in lateral section.
(20) A diffuser according to any clause herein, including a plurality of outlet jets operatively connected to respective ones of the radially outwardly-extending passageways, with each said outlet jet having an inner circumference to cross-sectional area ratio that is greater than that of a circle and/or square.
(21) A diffuser according to any clause herein, wherein the outlet jets are high velocity said outlet jets.
(22) A diffuser according to any clause herein, wherein the outlet jets are configured to direct the mixture substantially about and radially outwards from the diffuser.
(23) A diffuser according to any clause herein, wherein the diffuser is configured with a jet coverage which inhibits initial entrainment of the mixture upwards, thereby promoting a prolonged contact time between the bubbles and the body of water.
(24) A diffuser according to any clause herein, wherein the diffuser is configured with a jet coverage which inhibits initial entrainment of the mixture upwards for a predetermined or threshold amount of time, thereby promoting a prolonged contact time between the bubbles and the body of water.
(25) A diffuser according to any clause herein, wherein the diffuser is configured with a jet coverage which inhibits initial entrainment of the mixture upwards for a predetermined or threshold radially-outwardly extending distance, thereby promoting a prolonged contact time between the bubbles and the body of water.
(26) A diffuser according to any clause herein, wherein the diffuser is configured with a jet coverage which inhibits initial up flow of water, thereby reducing an initial plume rise velocity and with the mixture so spread outwards promoting additional contact time between the bubbles and the body of water.
(27) A diffuser according to any clause herein, wherein the diffuser is configured to inhibit initial upward velocity of the mixture outputted therefrom, thereby promoting creation of a lower initial plume flow upwards, decreasing the total water flow upwards, and increasing dissolved oxygen (DO) concentration within the body of water adjacent thereto.
(28) A diffuser according to any clause herein, wherein the diffuser is configured with a jet coverage which inhibits initial up flow of water, thereby reducing an initial plume rise velocity and enabling the diffuser to be positioned at shallower and/or less depth.
(29) A diffuser via which oxygen-containing gas is diffused into a body of water, the diffuser comprising: a hub having a plurality of circumferentially spaced-apart gas injection ports; an annular member extending about and enclosing in part the gas injection ports of the hub, the annular member having a plurality of circumferentially spaced and axially-extending openings extending therethrough, the openings aligning with respective said ports; an axially-constricting member having a plurality of circumferentially spaced and axially-extending passageways extending therethrough, the axially-extending passageways aligning with and being smaller in extent than respective said openings of the annular member; and a radially-extending member having a plurality of circumferentially spaced and radially outwardly-extending passageways, the radially outwardly-extending passageways aligning with and being in fluid communication with respective said axially-extending passageways.
(30) A diffuser of any clause herein, wherein each said opening is an annular sector in top and/or bottom profile.
(31) A diffuser of any clause herein, wherein the annular member includes a plurality of circumferentially spaced-apart and radially outwardly-extending elongate portions.
(32) A diffuser of any clause herein, wherein the elongate portions are shaped to divide incoming axial water flow and bubbles into multiple mixing channels or said axially-extending passageways.
(33) A diffuser of any clause herein, wherein each said intensifier comprises a constriction.
(34) A diffuser of any clause herein, wherein the hub, the annular member, the axially-constricting member and/or the radially-extending member, or any combination thereof, are integrally connected together so as to form a unitary whole.
(35) A diffuser of any clause herein, wherein the annular member, the axially-constricting member and/or the radially-extending member are planar.
(36) A diffuser of any clause herein, wherein the annular member comprises a channel splitting plate.
(37) A diffuser of any clause herein, wherein the annular member includes an annular peripheral portion.
(38) A diffuser of any clause herein, wherein the openings of the annular member are radially inwardly spaced from the peripheral portion of the annular member.
(39) A diffuser of any clause herein, wherein the elongate portions of the annular member operatively connect to the peripheral portion of the annular member.
(40) A diffuser via which oxygen-containing gas is diffused into a body of water, the diffuser comprising: a hub having a plurality of circumferentially spaced-apart gas injection ports; an annular member extending about and enclosing in part the gas injection ports of the hub; an axially-constricting member having a plurality of circumferentially spaced and axially-extending passageways extending therethrough, the axially-extending passageways aligning with respective ones of the gas injection ports; and a radially-extending member having a plurality of circumferentially spaced and radially outwardly-extending passageways, the radially outwardly-extending passageways aligning with and being in fluid communication with respective said axially-extending passageways.
(41) A diffuser of any clause herein, wherein the axially-constricting member comprises a plurality of axial intensifiers.
(42) A diffuser of any clause herein, wherein the axial intensifiers are interposed between respective said elongate portions.
(43) A diffuser of any clause herein, wherein the axial intensifiers are shaped to increase the velocity and turbulent kinetic energy (TKE) of the mixture of water and gas bubbles dispersed therewithin, with immediate dissipation of which thereafter inducing breaking of said gas bubbles down to smaller sizes.
(44) A diffuser of any clause herein, wherein the mixture of water and gas bubbles outputted from the axial intensifiers enter respective expansion chambers.
(45) A diffuser of any clause herein, wherein the flow of the mixture water and gas bubbles changes direction from an axial said flow into the expansion chamber to a radial said flow.
(46) A diffuser of any clause herein, wherein the combined expansion and direction change from axial to radial flow induces a homogeneous ramping turbulent kinetic energy (TKE) dissipation field, which results in gas bubble breakage and mixing thereof increases with the strength of the turbulent kinetic energy (TKE) dissipation field.
(47) A diffuser of any clause herein, wherein the mixture of water and gas bubbles exiting the expansion chambers is directed to radial intensifiers.
(48) A diffuser of any clause herein, wherein each said radial intensifier is configured to increase the prevailing turbulent kinetic energy (TKE) dissipation level in the expansion chamber.
(49) A diffuser of any clause herein, wherein each said radial intensifier is configured to create a highest said turbulent kinetic energy (TKE) dissipation level via which the gas bubbles are processed down to one or more final sizes.
(50) A diffuser of any clause herein, wherein the mixture of water and gas bubbles so reduced in size exit the radial intensifiers and transit to outlet jets.
(51) A diffuser of any clause herein, wherein each said radially-extending passageway includes an outer portion between the corresponding said radial intensifier and corresponding said outlet jet, with said outer portion being shaped to promote attachment of the mixture to walls thereof.
(52) A diffuser of any clause herein, wherein the radially-extending passageways are arranged to promote radially spreading of oxygenated water away from the diffuser.
(53) A diffuser of any clause herein, wherein for each said radially-extending passageway the outer portion thereof radially outwardly flares.
(54) A diffuser of any clause herein, wherein the diffuser is shaped to radially outwardly spread the mixture on a horizontal plane away therefrom.
(55) A diffuser of any clause herein, wherein the outlet jets align within a plane.
(56) A diffuser of any clause herein, wherein the diffuser is configured such that coverage of the outlet jets and radial velocity of the mixture outwards therefrom is significant enough to inhibit upward velocity of water everywhere but at extremities of a sprayed zone thereof.
(57) A diffuser of any clause herein, wherein the diffuser is configured such that coverage of the outlet jets and radial velocity of the mixture outwards therefrom substantially inhibits upward velocity of water except for at extremities of a sprayed zone thereof.
(58) A diffuser of any clause herein, wherein at the extremities of the sprayed zone the mixture begins rising and inhibited upward velocity induces a contraction of the plume above the diffuser, with said contraction combined with radial jets forming a recirculation zone immediately above the diffuser.
(59) A diffuser of any clause herein, wherein the diffuser is configured to include radially spreading jets of high coverage, creating one or more recirculation zones above the diffuser which function to trap very small bubbles and thereby enable additional contact time for said small bubbles.
(60) A diffuser of any clause herein, wherein the diffuser is configured to form a standard bubble plume above the contraction, with gas dissolution continuing, entrainment occurring, and the mixture rising to the surface, with the undissolved said gas next combining with the atmosphere, and the treated water radially spreading at or adjacent the surface away from the plume and mixing with the bulk water.
(61) A diffuser of any clause herein, wherein the radially-extending member is larger in extent and/or extends radially outwards from the hub, the annular member and/or the axially-constricting member.
(62) A diffuser of any clause herein, wherein the radially-extending member comprises a radial intensifier plate.
(63) A diffuser of any clause herein, wherein the diffuser is substantially cylindrical in outer shape.
(64) A diffuser via which oxygen-containing gas is diffused into a body of water, the diffuser comprising: a plurality of axially-extending channels, each being an annular sector in cross-section and being configured to receive water and gas therethrough; and a plurality of radially-extending channels above and operatively connected to respective said axially-extending channels.
(65) A diffuser according to any clause herein, wherein each said radially-extending channel has an outlet that is rectangular.
(66) A diffuser according to any clause herein, wherein each said radially-extending channel has a constriction.
(67) A diffuser according to any clause herein, wherein each said axially-extending channel has a constriction.
(68) A diffuser according to any clause herein, wherein each said axially-extending channel is in fluid communication with a respective said radially-extending channel via an expansion chamber.
(69) A diffuser according to any clause herein, wherein each said axially-extending channel has a reduced cross-sectional area.
(70) A diffuser according to any clause herein, wherein each said axially-extending channel has a reduced cross-sectional area between proximal and distal end portions thereof.
(71) A diffuser according to any clause herein, wherein each said axially-extending channel is shaped to direct flow radially inwards and then radially outwards.
(72) A diffuser according to any clause herein, wherein each said radially-extending channel has a longitudinal axis and is shaped to direct flow laterally outwards in part relative to said axis thereof and then laterally inwards in part towards said axis thereof.
(73) A diffuser according to any clause herein, wherein each said radially-extending channel has a longitudinal axis and is shaped to direct flow laterally outwards in part relative to said axis thereof, then laterally inwards in part towards said axis thereof and then laterally outwards in part relative to said axis thereof once more.
(74) A diffuser of any clause herein, wherein each said axially-extending passageway includes an axial intensifier.
(75) A diffuser of any clause herein, wherein each said axially-extending passageway includes an expansion chamber at a distal end portion thereof.
(76) A diffuser of any clause herein, wherein each said expansion chamber axially aligns with a respective said axial intensifier and/or said oxygen injection port and/or extends between an adjacent pair of said divider members.
(77) A diffuser of any clause herein, wherein each said axially-extending passageway includes a gas-liquid mixing chamber at a proximal end portion thereof.
(78) A diffuser of any clause herein, wherein each said axially-extending passageway includes a constriction between the proximal and distal end portions thereof.
(79) A diffuser of any clause herein, including a plurality of circumferentially spaced-apart and radially-extending or radial intensifiers.
(80) A diffuser of any clause herein, wherein each said radially-extending passageway includes a radially-extending or radial intensifier.
(81) A diffuser of any clause herein, wherein each said radially-extending passageway includes an expansion chamber at a proximal end portion thereof.
(82) A diffuser of any clause herein, wherein each said expansion chamber extends perpendicular to and radially outwards from a corresponding said axial intensifier.
(83) A diffuser of any clause herein, wherein each said expansion chamber has a lateral width to height ratio that is larger than that of the corresponding said axial intensifier.
(84) A diffuser of any clause herein, wherein each said expansion chamber in lateral section has a height and a width wider than the height thereof.
(85) A diffuser of any clause herein, wherein each said expansion chamber has a first portion or sub-chamber with a width that expands/enlarges radially and/or outwardly flares.
(86) A diffuser of any clause herein, wherein each said first portion or sub-chamber is polygonal in top/bottom view.
(87) A diffuser of any clause herein, wherein each said first portion or sub-chamber is substantially a quadrilateral in top/bottom view.
(88) A diffuser of any clause herein, wherein each said first portion or sub-chamber is substantially an isosceles trapezoid in top/bottom view.
(89) A diffuser of any clause herein, wherein each said first portion or sub-chamber is substantially hexagonal or an elongate and/or irregular hexagon in top/bottom view.
(90) A diffuser of any clause herein, wherein each said expansion chamber has a second portion or sub-chamber operatively connected to, adjacent and in fluid communication with the first sub-chamber thereof.
(91) A diffuser of any clause herein, wherein each said second sub-chamber has a width that contracts in a radially outwardly-extending direction.
(92) A diffuser of any clause herein, wherein each said second sub-chamber outwardly tapers.
(93) A diffuser of any clause herein, wherein each said second sub-chamber is an isosceles trapezoid in top/bottom profile.
(94) A diffuser of any clause herein, wherein each said expansion chamber is polygonal in top/bottom view.
(95) A diffuser of any clause herein, wherein each said expansion chamber is a six-sided polygon or hexagonal or an elongate and/or irregular hexagonal in shape in top/bottom view.
(96) A diffuser of any clause herein, wherein each said expansion chamber is an eight-sided polygon or octagonal or an elongate and/or irregular octagon in shape in top/bottom view.
(97) A diffuser of any clause herein, wherein the combined expansion and direction change of the mixture from axial to radial induces a homogeneous ramping turbulent kinetic energy (TKE) dissipation field.
(98) A diffuser of any clause herein, wherein gas bubble breakage and mixing increases with the strength of the turbulent kinetic energy (TKE) dissipation field.
(99) A diffuser of any clause herein, wherein each said radial intensifier operatively connects to, aligns with, is in fluid communication with and/or is downstream of a respective said expansion chamber.
(100) A diffuser of any clause herein, wherein each said radial intensifier is configured to increase a prevailing turbulent kinetic energy (TKE) dissipation level of the expansion chamber upstream thereof.
(101) A diffuser of any clause herein, wherein each said radial intensifier is configured to increase and/or maximize turbulent kinetic energy (TKE) dissipation levels.
(102) A diffuser of any clause herein, wherein each said radially-extending passageway includes an outlet jet at a distal end portion thereof.
(103) A diffuser of any clause herein, wherein each said radially-extending passageway includes a constriction between the proximal and distal end portions thereof.
(104) A diffuser via which oxygen-containing gas is diffused into a body of water, the diffuser comprising: a plurality of circumferentially spaced-apart gas injection ports; and a plurality of circumferentially spaced and radially-extending dividing members positioned between respective said oxygen injection ports, with the dividing members being configured to divide incoming axial water flow and bubbles into multiple mixing channels.
(105) A diffuser via which oxygen-containing gas is diffused into a body of water, the diffuser comprising: a plurality of circumferentially spaced-apart gas injection ports; a plurality of circumferentially spaced and axially-extending passageways aligning with and in fluid communication with respective ones of said ports; and a plurality of circumferentially spaced and radially outwardly-extending expansion chambers aligning with and in fluid communication with respective ones of said axially-extending passageways.
(106) A diffuser via which oxygen-containing gas is diffused into a body of water, the diffuser comprising: a plurality of circumferentially spaced-apart gas injection ports; a plurality of circumferentially spaced and axially-extending intensifiers or constrictions aligning with and in fluid communication with respective ones of said ports so as to promote passageway of fluid axially upwards; and a plurality of circumferentially spaced and radially outwardly-extending expansion chambers aligning with and in fluid communication with respective ones of said intensifiers.
(107) A diffuser via which oxygen-containing gas is diffused into a body of water, the diffuser comprising: at least one gas injection port; a first elongate passageway in fluid communication with the gas injection port and extending along a first axis; and a second elongate passageway aligning with and in fluid communication with the first elongate passageway, the second elongate passageway extending along a second axis perpendicular to the first axis; wherein the first elongate passageway in lateral section has a height to width ratio that is greater than that of the second elongate passageway.
(108) A diffuser according to any clause herein, wherein the second elongate passageway in lateral section has a height to width ratio in lateral section equal to or less than 1:2.
(109) A diffuser according to any clause herein, wherein the first elongate passageway in lateral section has a height to width ratio in lateral section that is up to two times or greater than that of the second elongate passageway.
(110) A diffuser according to any clause herein, wherein the first elongate passageway in lateral section has a height to width ratio in lateral section that is greater than two times that of the second elongate passageway.
(111) A diffuser via which oxygen-containing gas is diffused into a body of water, the diffuser comprising: at least one gas injection port; a first elongate passageway in fluid communication with the gas injection port and extending along a first axis; and a second elongate passageway aligning with and in fluid communication with the first elongate passageway, the second elongate passageway extending along a second axis perpendicular to the first axis; wherein the second elongate passageway is wider in lateral cross-section than that of the first elongate passageway and/or the second elongate passageway is rectangular in lateral cross-section.
(112) A diffuser according to any clause herein, wherein the first elongate passageway is substantially square, rectangular and/or non-circular, in lateral cross-section.
(113) A diffuser according to any clause herein, wherein the second elongate passageway is substantially rectangular in lateral cross-section.
(114) A diffuser via which oxygen-containing gas is diffused into a body of water, the diffuser comprising: at least one gas injection port; at least one axially-extending passageway in fluid communication with the gas injection port; and at least one radially outwardly-extending passageway aligning with and in fluid communication with the at least one axially-extending passageway, wherein each said passageway has a constriction.
(115) A diffuser according to any clause herein, wherein the at least one radially outwardly-extending passageway is shaped to taper towards the constriction thereof and flare outwards downstream of the constriction thereof.
(116) A diffuser via which oxygen-containing gas is diffused into a body of water, the diffuser comprising: at least one gas injection port; at least one axially-extending passageway in fluid communication with the gas injection port; and at least one radially outwardly-extending passageway aligning with and in fluid communication with the at least one axially-extending passageway, wherein the at least one radially outwardly-extending passageway has a constriction and wherein the at least one radially outwardly-extending passageway is shaped to taper towards the constriction thereof and flare outwards downstream of the constriction thereof.
(117) A diffuser of any clause herein, wherein the diffuser is configured to both distribute and process/promote-dissolution of oxygen within the body of water.
(118) A diffuser of any clause herein, wherein the diffuser is configured to combine a pumped water stream and a pressurized concentrated oxygen gas stream.
(119) A diffuser of any clause herein, wherein the diffuser is configured to process the gas stream into small/fine bubbles and disperse said bubbles through the pumped water stream.
(120) A diffuser of any clause herein, wherein the diffuser is configured to circumferentially and radially disperse and/or jet away therefrom the water and gas stream so combined and processed.
(121) A diffuser of any clause herein, wherein the diffuser is configured to promote formation of a plurality of recirculation zones above the diffuser, with the gas bubbles rising therearound before forming a radially-outwardly extending bubble plume.
(122) A diffuser of any clause herein, wherein the diffuser is configured to promote formation of a bubble plume with a lower portion that tapers upwards and an upper portion that outwardly-flares upwards.
(123) A diffuser of any clause herein, wherein the plurality of recirculation zones are enclosed within the first bubble plume portion of the diffuser.
(124) A diffuser of any clause herein, wherein each said portion of the bubble plume is generally or substantially frustoconical in shape.
(125) A diffuser via which oxygen-containing gas is diffused into a body of water, the diffuser being configured to direct bubble-containing water radially and circumferentially outwards therefrom so as to form a first bubble plume portion that tapers in an upward direction, with a plurality of circumferentially spaced-apart recirculation zones comprising outwardly positioned water flowing both upwards and radially inwards and then axially downwards towards the diffuser once more, and so as to form a second bubble plume portion that flares outwards in the upward direction.
(126) A diffuser via which oxygen-containing gas is diffused into a body of water, the diffuser comprising: a plurality of pathways via which gas bubbles are dispersed within a flow of water and directed axially upwards and then radially outwards, with each said pathway being shaped to undergo in lateral section a height to width ratio change in the transition between axial and radial said flow.
(127) A diffuser of any clause herein, wherein the pathways are circumferentially spaced-apart.
(128) A diffuser of any clause herein, wherein each said pathway has an axially-extending passageway and a radially-extending passageway with a width greater than the axially-extending portion thereof.
(129) A diffuser of any clause herein, wherein each said axially-extending passageway is generally square in lateral section.
(130) A diffuser of any clause herein, wherein each said pathway is shaped to reduce mixing length and promote gas phase dispersion.
(131) A diffuser of any clause herein, wherein for each said pathway the transition from said axially-extending passageway of a first height in lateral section to said radially-extending passageway of a second height in lateral section which is less than said first height in lateral section, functions to reduce mixing length and promote gas phase dispersion.
(132) A diffuser of any clause herein, wherein each said pathway is shaped to cause the mixture of gas bubbles and water to undergo a first acceleration and/or increased velocity in an axial direction.
(133) A diffuser of any clause herein, wherein each said pathway is shaped to cause the mixture of gas bubbles and water to undergo a second acceleration and/or increased velocity in a radially outwardly-extending direction.
(134) A diffuser of any clause herein, including a gas injection hub shaped to receive the gas and through which extend said injection ports.
(135) A diffuser of any clause herein, wherein the gas injection hub is outwardly convex.
(136) A diffuser of any clause herein, wherein the gas injection hub is hemispherical in shape.
(137) A diffuser of any clause herein, wherein the gas injection hub is downward facing in use.
(138) A diffuser of any clause herein, wherein the gas outputted from the injection ports forms an initial bubble distribution concentrated adjacent the gas injection hub.
(139) A diffuser of any clause herein, wherein the gas injection hub is centrally located.
(140) A diffuser of any clause herein, wherein the diffuser has a longitudinal axis and the gas injection hub is coaxial with the longitudinal axis thereof.
(141) A diffuser of any clause herein, wherein the gas injection ports are positioned to be tangential to the flow of water.
(142) A diffuser of any clause herein, wherein the gas injection ports are positioned to be subject to a continuous water crossflow.
(143) A diffuser of any clause herein, wherein the gas injection hub includes a spherical snubber at a bottom thereof and which functions to inhibit pressure loss.
(144) A diffuser of any clause herein, wherein the water crossflow occurs naturally with minimal and/or substantially zero associated pressure loss.
(145) A diffuser of any clause herein, wherein the gas injection hub is shaped such that axial flow of water thereover creates a liquid shear over each said gas injection port, which inhibits formation of enlarged bubbles outwards from or adjacent the ports.
(146) A diffuser via which oxygen-containing gas is diffused into a body of water, the diffuser comprising: at least one axially-extending passageway shaped to receive a mixture of water and bubbles therethrough; an axial intensifier or constriction within the at least one axially-extending passageway; and a width-expanding, radially-extending expansion chamber downstream of the axial intensifier.
(147) A diffuser according to any clause herein, wherein the diffuser is shaped to create a height-homogeneous, linearly ramping turbulent kinetic energy (TKE) dissipation field, with the homogeneity thereof promoting breaking of initial bubbles regardless of location.
(148) A diffuser according to any clause herein, wherein the diffuser is shaped to position gas bubbles at a location of highest velocity and/or towards a top of the expansion chamber, which forces the bubbles to disperse throughout the water flow due to the large velocity gradient, thereby inducing significant mixing and bubble break up in the expansion chamber.
(149) A diffuser according to any clause herein, wherein the transition from axial to radial flow of the mixture functions as an initial bubble break up and disperses the gas bubbles well throughout the water flow.
(150) A diffuser according to any clause herein, wherein the axial-inflow and rapid expansion function as an effective mixing chamber, inhibiting local hotspots of gas holdup.
(151) A diffuser according to any clause herein, wherein momentum dissipation induced by the rapid direction transition of the mixture promotes creation of a well-mixed flow.
(152) A diffuser according to any clause herein, wherein bubble buoyancy encourages the gas bubbles to fight against the movement forced by the velocity gradient, promoting mixing thereof.
(153) A diffuser according to any clause herein, wherein the axial intensifier functions to restrict and/or direct flow radially inwards along the axially-extending passageway and this combined with an upward axial flow direction encourages the gas bubbles to fight against the movement forced by the velocity gradient, promoting mixing thereof.
(154) A diffuser of any clause herein, wherein the oxygen gas bubbles so formed are configured to continually undergo mass transfer from a gaseous phase to dissolved oxygen (DO), raising the DO concentration of the water within and/or adjacent the bubble plume.
(155) A diffuser of any clause herein, wherein the diffuser is configured to receive pressurized water and/or a pumped water stream/source therein/therethrough.
(156) A diffuser of any clause herein, wherein the diffuser is configured to be transportable and/or selectively deployable.
(157) A diffuser of any clause herein, wherein the gas has an enriched concentration of oxygen.
(158) A diffuser via which oxygen-containing gas is diffused into a body of water, the diffuser comprising: at least one axially-extending passageway shaped to receive a mixture of water and bubbles therethrough; and at least one radially-extending passageway and expansion chamber downstream of the at least one axially-extending passageway, wherein each said passageway has a constriction.
(159) A diffuser according to any clause herein, wherein for the at least one radially-extending passageway the constriction thereof is between proximal and distal end portions thereof.
(160) A diffuser according to any clause herein, wherein for the at least one axially-extending passageway the constriction thereof is downwardly spaced from the at least one radially-extending passageway.
(161) A diffuser according to any clause herein, wherein for the at least one axially-extending passageway the constriction thereof is between proximal and distal end portions thereof.
(162) A diffuser via which oxygen-containing gas is diffused into a body of water, the diffuser comprising: an axially-extending passageway shaped to receive a mixture of water and gas bubbles and shaped to increase the velocity and turbulent kinetic energy (TKE) of the mixture; and a radially-extending passageway downstream of the axially-extending passageway, configured to re-direct flow of the mixture from an axial to a radial direction; wherein the diffuser is shaped to induce a homogeneous ramping turbulent kinetic energy (TKE) dissipation field.
(163) A diffuser according to any clause herein, wherein the width to height ratio in lateral section change from the axially-extending passageway to the radially-extending passageway, together with an expansion chamber positioned between the passageways and shaped to promote mixing of the mixture, creates a homogeneous turbulent kinetic energy (TKE) dissipation field.
(164) A diffuser according to any clause herein, including an axial intensifier element positioned within the axially-extending passageway and shaped to increase the velocity and turbulent kinetic energy (TKE) of the mixture.
(165) A diffuser according to any clause herein, including a radial intensifier element positioned within the radially-extending passageway and including an expansion chamber positioned between the axial intensifier element and the radial intensifier element, with the radial intensifier element being shaped to increase the prevailing turbulent kinetic energy (TKE) level of the expansion chamber.
(166) A diffuser via which oxygen-containing gas is diffused into a body of water, the diffuser comprising: an axially-extending passageway shaped to receive a mixture of water and gas bubbles; an axial intensifier element positioned within the axially-extending passageway and shaped to increase the velocity and turbulent kinetic energy (TKE) of the mixture; and a radially-extending passageway downstream of the axial intensifier element which causes the mixture to change from an axial to a radial direction and which induces a homogeneous ramping turbulent kinetic energy (TKE) dissipation field.
(167) A diffuser according to any clause herein, wherein the radial intensifier is configured to create a stronger turbulent kinetic energy (TKE) dissipation field than that found in the expansion chamber, linearly ramping turbulent kinetic energy (TKE) dissipation as it transits the intensifier.
(168) A diffuser via which oxygen-containing gas is diffused into a body of water, the diffuser comprising: at least one axially-extending passageway shaped to receive a mixture of gas bubbles and water therethrough and configured to produce a first venturi effect thereon; and at least one radially-extending passageway downstream of the at least one axially-extending passageway and configured to produce a second venturi effect on said mixture.
(169) A diffuser comprising: a plurality of circumferentially spaced-apart gas injection ports; a plurality of circumferentially spaced-apart and axially-extending passageways, each aligning with a respective one of the gas injection ports, being shaped to receive a mixture of water and oxygen-containing gas therethrough and/or including an axial intensifier or constriction; a plurality of circumferentially spaced-apart and radially outwardly-extending passageways, each being in fluid communication with a respective one of the axially-extending passageways and/or including a radial intensifier or constriction between proximal and distal end portions thereof; and a plurality of circumferentially spaced-apart expansion chambers each positioned between and in fluid communication with a respective said axially-extending passageway and a corresponding respective said radially-extending passageway; wherein the diffuser is shaped for each said expansion chamber to induce a homogeneous ramping turbulent kinetic energy (TKE) dissipation field therein and wherein the diffuser is shaped for each said radial intensifier to promote a peak said turbulent kinetic energy (TKE) dissipation adjacent thereto.
(170) A diffuser via which oxygen-containing gas is diffused into a body of water, the diffuser comprising: a plurality of circumferentially spaced-apart and axially-extending passageways shaped to receive and increase the velocity of a mixture of gas bubbles and water extending therethrough; a plurality of expansion chambers downstream of respective ones of said axially-extending passageways; and a plurality of circumferentially spaced-apart and radially-extending passageways downstream of respective ones of said expansion chambers, the radially-extending passageways being shaped to receive and increase the velocity of the mixture once more so as to jet and/or eject said mixture about and radially-outwards from the diffuser.
(171) A diffuser according to any clause herein, wherein the diffuser is an aquaculture said diffuser.
(172) A diffuser according to any clause herein, wherein the axially-extending passageways extend laterally from the annular member radially-inwards.
(173) A diffuser according to any clause herein, wherein the axially-extending passageways extend laterally from the hub to the annular member.
(174) A diffuser according to any clause herein, wherein the annular member has a bottom positioned downwards from the bottom of the hub.
(175) A diffuser according to any clause herein, wherein the annular member extends about and encloses the sides of the hub.
(176) A diffuser according to any clause herein, wherein the proximal end portion of each said axially-extending passageway comprises a conduit or annular member extending at least in part about the hub and/or gas injection ports thereof.
(177) A diffuser according to any clause herein, wherein each said axially-extending passageway shares the same said proximal end portion thereof.
(178) A diffuser according to any clause herein, wherein the proximal end portion of the axially-extending passageways comprises an annular space or opening which extends about the hub and/or gas injection ports thereof.
(179) A diffuser according to any clause herein, comprising at least a first axially-extending passageway and corresponding radially-extending passageway extending therethrough and at least a second axially-extending passageway and corresponding radially-extending passageway extending therethrough.
(180) A diffuser according to any clause herein, comprising at least a third axially-extending passageway and corresponding radially-extending passageway extending therethrough and/or at least a fourth axially-extending passageway and corresponding radially-extending passageway extending therethrough.
(181) A diffuser according to any clause herein, wherein each quadrant thereof includes at least one axially-extending passageway and at least one corresponding radially-extending passageway extending therethrough.
(182) A diffuser according to any clause herein, wherein each quadrant thereof includes at least one axial constriction or intensifier and at least one corresponding radial constriction or intensifier.
(183) A diffuser according to any clause herein, wherein the axially-constricting member and the radially-extending member are co-extensive.
(184) A diffuser according to any clause herein, wherein for each said expansion chamber the first portion sub-chamber thereof is polygonal in top/bottom profile.
(185) A diffuser according to any clause herein, wherein for each said expansion chamber the first portion sub-chamber thereof is hexagonal and/or an elongate and/or irregular hexagonal in top/bottom profile.
(186) A diffuser according to any clause herein, wherein each said axially-extending passageway laterally tapers and/or narrows radially inwards.
(187) A diffuser according to any clause herein, wherein each said axially-extending passageway laterally flares outwards relative a respective/adjacent said gas injection port.
(188) A diffuser according to any clause herein, wherein each said axially-extending passageway is wider adjacent the annular member.
(189) A diffuser according to any clause herein, wherein for each said expansion chamber the first portion or sub-chamber thereof is octagonal and/or an elongate and/or irregular octagonal in top/bottom profile.
(190) Use of a diffuser of any clause herein to direct bubble-containing water radially and circumferentially outwards therefrom so as to form a first bubble plume portion that tapers in an upward direction, with a plurality of circumferentially spaced-apart recirculation zones comprising rising water flowing radially inwards and then axially downwards towards the diffuser once more, and so as to form a second bubble plume portion that flares outwards in the upward direction.
(191) An oxygenation assembly comprising: a diffuser according to any clause herein; and a pump via which water is directed to the diffuser.
(192) An oxygenation assembly according to any clause herein, wherein the pump is a submersible water said pump configured to pump bulk water at a depth, with the water so pumped being pressurized and being directed to the diffuser.
(193) An oxygenation assembly according to any clause herein, wherein the diffuser operatively couples to the pump via a conduit.
(194) An oxygenation assembly according to any clause herein, wherein the diffuser operatively couples to the pump via a manifold.
(195) An oxygenation assembly accordingly to any clause herein, including or being connectable to a pressurized oxygen-enriched gas source via which oxygen-containing gas and/or a pressurized concentrated oxygen gas stream/source is directed to the diffuser.
(196) An oxygenation assembly according to any clause herein, wherein the annular member is part of a mount and/or manifold assembly of the diffuser.
(197) An oxygenation assembly according to any clause herein, wherein the annular member is shaped to form a continuous annular opening or space configured to enable passage of water and bubbles axially therethrough.
(198) An oxygenation assembly according to any clause herein, wherein the axially-constricting member is in fluid communication with and directly couples to the annular member.
(199) An oxygenation assembly according to any clause herein, wherein the manifold assembly and/or annular member thereof are configured to promote axial flow of water and gas bubbles towards the axially-extending passageways.
(200) An oxygenation assembly according to any clause herein, wherein the manifold assembly includes an annular member shaped to extend about the hub and/or gas injection ports thereof.
(201) An oxygenation assembly according to any clause herein, wherein the diffuser is selectively connectable to and removable from the manifold assembly thereof.
(202) A method of diffusing and/or dissolving gas bubbles in water via a diffuser, the method comprising: jetting via the diffuser bubble-containing water radially and circumferentially outwards so as to form a first bubble plume portion that tapers in an upward direction; entraining water adjacent thereto via said jetting so as to form a plurality of circumferentially spaced-apart recirculation zones comprising rising water flowing radially inwards and then axially downwards towards the diffuser once more, and so as to form a second bubble plume portion that flares outwards in the upward direction.
(203) A method of diffusing and/or dissolving gas bubbles in water via a diffuser, the method comprising: jetting radially outwards via the diffuser bubble-containing water so as to form a bubble plume; entraining water adjacent thereto via said jetting so as to form a plurality of circumferentially spaced-apart recirculation zones comprising rising water flowing radially inwards and then axially downwards towards the diffuser once more; and causing the bubble plume to taper inwards via said recirculation zones.
(204) A method according to any clause herein, wherein the bubble plume is shaped to flare outwards above the recirculation zone.
(205) A method of forming a bubble plume with a prolonged contact time between gas bubbles and a body of water to which the bubbles are dispersed, with the method comprising: jetting radially and circumferentially outwards via a diffuser a mixture of the gas bubbles and water at a velocity sufficient to i) inhibit initial entrainment of the mixture upwards, thereby promoting a prolonged contact time between the bubbles and the body of water; and ii) promote entrainment exterior to the diffuser, and thereby increasing water flow in the jetting, decreasing gas holdup within the diffuser, and inhibiting bubble coalescence.
(206) A method according to any clause herein, including configuring the diffuser to output the mixture of the gas bubbles and water at a velocity sufficient to initially inhibit entrainment of the mixture upwards for a predetermined or threshold amount of time.
(207) A method according to any clause herein, including configuring the diffuser to output the mixture of the gas bubbles and water at a velocity sufficient to initially inhibit entrainment of the mixture upwards for a predetermined or threshold radially-outwardly extending distance.
(208) Apparatus including any new and inventive feature, combination of features, or sub-combination of features as described herein.
(209) Methods including any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A diffuser via which oxygen-containing gas is diffused into a body of water, the diffuser comprising:
a plurality of axially-extending passageways, each shaped to receive oxygen-injected said water therethrough; and
a plurality of radially-extending passageways downstream of respective said axially-extending passageways and via which the oxygen-injected said water is directed radially outwards.

2. A diffuser according to claim 1, wherein the plurality of axially-extending passageways are circumferentially spaced-apart, and wherein the plurality of radially-extending passageways are circumferentially spaced-apart.

3. A diffuser according to claim 1, wherein the plurality of radially-extending passageways are operatively connected to and above the plurality of axially-extending passageways, and wherein the diffuser primarily breaks up bubbles in the transition of oxygen-injected said water being directed from axially upwards to radially outwards.

4. A diffuser of claim 1, including a plurality of axial intensifiers or constrictions each in fluid communication with or a part of a respective one of the plurality of axially-extending passageways, the axial intensifiers or constrictions being shaped to increase the velocity and turbulent kinetic energy (TKE) of a mixture of water and gas bubbles dispersed therewithin, with immediate dissipation of which thereafter inducing breaking of said gas bubbles down to smaller sizes.

5. A diffuser according to claim 1, wherein each said radially-extending passageway has a longitudinal axis, and wherein each said radially-extending passageway is shaped to direct flow laterally outwards in part relative to the axis thereof, then laterally inwards in part towards the axis thereof, and then laterally outwards in part relative to the axis thereof once more.

6. A diffuser of claim 1, including a plurality of expansion chambers each downstream of a respective one of the plurality of axially-extending passageways.

7. A diffuser of claim 6, wherein each said expansion chamber has a first portion or sub-chamber which outwardly flares and/or has a width that expands/enlarges radially, wherein each said expansion chamber has a second portion or sub-chamber operatively connected to, adjacent and in fluid communication with the first sub-chamber thereof, and wherein each said second sub-chamber outwardly tapers and/or has a width that contracts in a radially outwardly-extending direction.

8. A diffuser of claim 6, wherein the combined expansion and direction change from axial flow to radial flow induces a homogeneous ramping turbulent kinetic energy (TKE) dissipation field, which results in gas bubble breakage and mixing thereof increases with the strength of the turbulent kinetic energy (TKE) dissipation field.

9. A diffuser of claim 1, including a plurality of radial intensifiers or constrictions each in fluid communication with or a part of a respective one of the plurality of radially-extending passageways.

10. A diffuser of claim 9, wherein each said radial intensifier or constriction is configured to increase and/or maximize turbulent kinetic energy (TKE) dissipation levels and/or wherein each said radial intensifier or constriction is configured to create a highest said turbulent kinetic energy (TKE) dissipation level via which gas bubbles are processed down to one or more final sizes.

11. A diffuser of claim 1, wherein the diffuser includes a plurality of expansion chambers each downstream of a respective one of the plurality of axially-extending passageways, and wherein the diffuser includes a plurality of radial intensifiers or constrictions each in fluid communication with or a part of a respective one of the plurality of radially-extending passageways and being downstream of a respective one of the expansion chambers.

12. A diffuser of claim 11, wherein: the diffuser is shaped for each said expansion chamber to induce a homogeneous ramping turbulent kinetic energy (TKE) dissipation field therein; each said radial intensifier is configured to increase the prevailing turbulent kinetic energy (TKE) dissipation level in the corresponding said expansion chamber; and/or the diffuser is shaped for each said radial intensifier to promote a peak said turbulent kinetic energy (TKE) dissipation adjacent thereto.

13. A diffuser according to claim 1, wherein the plurality of radially-extending passageways have distal openings which are: non-square, non-circular, and/or rectangular in lateral section; and/or shaped to promote entrainment exterior to the diffuser, and thereby increasing water flow in a jet, decreasing gas holdup within the diffuser, and inhibiting bubble coalescence.

14. A diffuser according to claim 1, wherein the diffuser is shaped to provide a jet coverage which: inhibits initial entrainment of a gas-bubble and water mixture upwards for a predetermined or threshold amount of time and/or predetermined or threshold radially-outwardly extending distance, thereby promoting a prolonged contact time between the bubbles and the body of water; inhibits up flow of water, thereby reducing an initial plume rise velocity and with the gas-bubble and water mixture so spread outwards promoting additional contact time between the bubbles and the body of water; and/or inhibits initial upward velocity of the gas-bubble and water mixture outputted therefrom, thereby promoting creation of a lower initial plume flow upwards, decreasing the total water flow upwards, and increasing dissolved oxygen (DO) concentration within the body of water adjacent thereto.

15. A diffuser according to claim 1, including a plurality of circumferentially spaced-apart gas injection ports each aligning with a respective one of the plurality of axially-extending passageways.

16. A diffuser according to claim 15, wherein the diffuser includes a hub including said plurality of circumferentially spaced-apart gas injection ports, wherein the diffuser includes an annular member extending about and enclosing in part the gas injection ports of the hub, wherein the diffuser includes an axially-constricting member including said plurality of circumferentially spaced and axially-extending passageways extending therethrough, and wherein the diffuser includes a radially-extending member defining said plurality of radially-extending passageways.

17. A diffuser according to claim 1, wherein each axially-extending passageway and corresponding said radially-extending passageway comprises a pathway shaped to undergo in lateral section a height to width ratio change in the transition between axial and radial flow and/or wherein each of the plurality of radially-extending passageways in lateral section has a height to width ratio that is i) less than that of each of the plurality of axially-extending passageways and/or ii) equal to or less than 1:2 that of each of the plurality of axially-extending passageways.

18. An oxygenation assembly comprising:
a diffuser according to claim 1; and
a pump via which water is directed to the diffuser, wherein the pump is a submersible water said pump configured to pump bulk water at a depth, with the water so pumped being pressurized and being directed to the diffuser.

19. A diffuser via which oxygen-containing gas is diffused into a body of water, the diffuser comprising:
an axially-extending passageway shaped to receive a mixture of water and gas bubbles and increase the velocity and turbulent kinetic energy (TKE) of the mixture; and
a radially-extending passageway downstream of the axially-extending passageway so as to re-direct flow of the mixture from an axial to a radial direction, wherein the diffuser is shaped to induce a homogeneous ramping turbulent kinetic energy (TKE) dissipation field.

20. A diffuser via which oxygen-containing gas is diffused into a body of water, the diffuser comprising:
at least one gas injection port;
at least one axially-extending passageway aligning with and in fluid communication with the gas injection port; and
at least one radially outwardly-extending passageway aligning with and in fluid communication with the at least one axially-extending passageway, wherein the at least one radially outwardly-extending passageway has a constriction and wherein the at least one radially outwardly-extending passageway is shaped to taper towards the constriction thereof and flare outwards downstream of the constriction thereof.
